(19) United States
(12) Patent Application Publication
(10) Pub. No.: US 2008/0148398 A1
(43) Pub. Date: Jun. 19, 2008

(54) System and Method for Definition and Automated Analysis of Computer Security Threat Models

(76) Inventors: Derek John Mezack, Jasper, GA (US); David M. Hodges, Canton, GA (US); Donald Jay Hodges, Atlanta, GA (US)

Correspondence Address: PARKS KNOWLTON - PK001, 1117 PERIMETER CENTER WEST, SUITE E402, ATLANTA, GA, 30338, US

(21) Appl. No.: 11/555,031

(22) Filed: Oct. 31, 2006

(51) Int. Cl. G06F 21/00

(52) U.S. Cl. 726/22; 709/224

(57) ABSTRACT

A network security analysis tool and related systems and methods are disclosed. The disclosed invention can accept user input to define network security threat models. The system can collect event data from one or more network devices and analyze that data for the existence of activity matching the defined threat models. The collected data can be translated into a common format for storage in a database of the invented system. The system can create threat models to track network threats found in the collected data that both partially and completely match one or more threat model definitions. The resulting threat models can be displayed on a console to show threat progression in near real time.

### TECHNICAL FIELD

The present invention relates to digital systems and the security of such systems. More specifically, the invention relates to a method and system for defining models of threats to digital systems and an automatable process of analyzing ongoing security activity to identify and monitor the existence of both partial and complete threat models in near real time.

### BACKGROUND OF THE INVENTION

Over the history of digital devices being used to both host and automate data assets in both personal and business affairs, there has always been associated risks and threats to such systems and their related assets. Threats to such systems vary in intention and technique, but often impact the confidentiality, integrity, availability, and privacy of such systems or their related assets.

In an effort to detect and sometimes prevent such intrusions, both border and sensor computer software has been developed and used, often times in multiple environments and configurations where protection is sought. Some sensor infrastructures focus on the monitoring of network communications between systems on a technical level, while others monitor local system activity, while many others still monitor the human content aspect of communications. Each of these sensor systems is useful in quickly identifying pertinent activity to ongoing threats and in some cases taking actions to prevent them. However, each of these types of systems and the devices utilized therein possess both individual and shared problems in being able to derive sufficient decision-making information using only their individual forms of predefined patterns to detect threat activity.

Often, sensor devices are placed in multiple locations, giving visibility to threat related data from different locale perspectives. Regardless of the scenario in which these devices are used, each device is highly limited in capabilities of detecting strategic threats to digital assets by the fact that they often cannot communicate with each other, to take advantage of each others' locale perspective to more accurately draw decision making material regarding related threat activity. This problem is typically due to vendors of such products specializing in different aspects of detection and no common language or storage mechanism being shared across disparate devices. The lack of communication often causes false negatives (actual threats which were not identified that did come to pass) and false positives (innocuous activity identified as a threat) due to threats being falsely identified both without sufficient information.

Conventional sensor devices identify specific patterns of technical activity, usually focused within a very short period of time due to computing power, locale, and pattern constraints. Each of these items reported, referred to commonly as events, generally have no relationship demonstrated between each other. In order to effectively evaluate and respond to ongoing threat activity, it is often times required to understand the behavioral aspect of a given threat, just as a conventional threat model begins with an understanding of a potential adversary's view. Adequate view of an ongoing threat is more commonly understood by both the individual actions of an adversary and the relationship of those actions to each other in a given environment. For instance, consider the case of a “worm”, comprising a malicious piece of software which attempts to propagate from machine to machine in a given environment by executing a given attack to all machines surrounding the compromised machine. In this situation, a conventional sensor device would report individual events representing individual attacks between various machines involved in the threat, typically provided in flat list. However, effective illustration of such an attack requires the identification of the threat's point of entry, and behavior pattern to identify its course of propagation. Without this, response to such an attack would lack direction as to which machines may require more immediate attention based on their relationship to other machines and the worm's level of success in compromising them.

Conventional sensor devices often vary in the type of data they produce based on the type of activity being monitored or the nature of threats being identified. For example, privacy content monitoring solutions monitor the human aspect of computer communications for threat activity based on human linguistic behavior. Anomaly based systems look for deviances from baseline or standard bars of normalcy, while many other sensor devices utilize predefined signatures of accepted negative behavior. The disparity in both detection and the resulting data of each of these devices and their related vendors has caused a lack of analysis capability that can effectively make use of detecting threats that cross each of their related types of resulting information impossible.

Conventional sensor devices often times make identification decisions based primarily or solely on predefined mechanisms of activity with little or no input. Since there are many differences and limited standards concerning the environment, design, and intended use of digital assets to support user needs, conventional mechanisms for threat event detection often times depend on, and are limited to, threats that can be identified without knowledge of the monitored environment. To be effective, threat modeling begins with an understanding of a potential adversary's view. This often times requires asset and operational knowledge as a given attack is related both to the high level use of digital assets and their technical function in a given environment. Without this knowledge or ability for model definition, conventional sensor and analysis devices are unable to effectively identify many critical threats in data activity. For instance, some forms of legitimate activity, such as file sharing, may be appropriate between many systems comprising a given network. However, communication between key systems or users of this nature, potentially even limited to specific content, can represent a threat. Without a framework for custom model definition of threats specific to a given environment in place, many threats to current environments go undetected.

Many computer system environments involve the use of proprietary technology or applications as part of normal business. These software applications can sometimes even be core to the most critical of data and operational assets of a given environment. Conventional sensor devices and analysis systems, while sometimes able to detect common predefined events related to proprietary technology activity, do not provide a means for threat models to be identified and detected by those who know and use the technology. Many digital assets can produce activity related data sufficient to detect ongoing threats, but this data cannot be analyzed optimally because those threats are not part of generally predefined signatures in related security devices or are not used as part of threats predefined in analysis devices.

The process of detection in many conventional sensor devices involves a mechanism that identifies singular instances of security events. Once an event is detected, the system moves on to detecting other events or the same event without the correlation of new instances of activity sharing the same source, target, or impact that make it part of the same threat model. Some forms of analysis will attempt to identify sequential events in activity, but even this form of analysis often results in a single notification of predefined activity without ongoing support of monitoring of each point in the threat model. While tracking a given ongoing threat, knowledge of the ongoing existence of each step in a given model is required to effectively ascertain the overall threat to a given target, aid in the identification of potential strategic targets, and confirm or negate the effectiveness of response strategies.

While some forms of analysis attempt to identify attack strategies by looking for the existence of specific predefined sequential events, these systems are incapable of following a threat model that branches to multiple potential following steps at the same time. For instance, if a worm infects a given network, conventional analysis systems will follow each instance of the worm attempting to propagate to a given target individually, without the capability for maintaining a singular threat model relationship between each instance and correlating both successful and unsuccessful cases of propagation together. This problem increases the inability of monitors to accurately identify threat models and respond to them, producing increased bulk data and lacking pertinent decision making information as to the progress of an identified threat.

Conventional devices used to perform corroboration of events utilize predefined techniques which are executed with little or no contextual knowledge against all event activity recorded. Due to the lack of knowledge about the environment and an overall lack of customization available to users knowledgeable about the environment, including specifically what should be corroborated and how, current corroboration methods and systems are often times inaccurate and insufficient for trustworthy results. Many of these systems simply match a given signature of a specific security event to a related vulnerability provided by assessment data. However, many events provided by non-signature-based detection mechanisms, such as in anomaly detection, sense more general things, such as “long” commands, etc., that do not correspond specifically to any given vulnerability. In addition, some methods of corroborating activity are considered invasive and even potentially illegal if performed on digital systems that are outside of the user's ownership, even if those systems are related to detected events.

Accordingly, there is a need in digital security for a method and process for defining threat models to digital assets. A further need exists in the art for a method by which threat models can be defined that can describe data from disparate types of data sources.

Another need exists for a method and system for identifying and monitoring both the partial and complete existence of defined threat model activity in ongoing data activity. That is, there is a need in the art for security personnel to identify their understanding of an adversary's view, characterize the security of their system and potential sources of visibility to threats, and identify and monitor ongoing threats that are modeled.

Yet another need exists in the art for a method and system for defining both policy and assigned strategies that determine what activity should be corroborated and how identified activity should be corroborated respectively.

### SUMMARY OF THE INVENTION

The present invention provides a system for analyzing security related network activity. The invented system can comprise a common data event database configured to store device event data in a common data event format and a threat model analysis engine. The threat model analysis engine can be configured to read common event data from the common data event database, analyze the common event data by comparing the common event data to a threat model definition, and generate a threat model instance corresponding to the threat model definition if a set of requirements of the definition is met by the common event data.

The common data event format can include fields for a source Internet protocol address, a delimiter, a source port, a destination Internet protocol address, a delimiter, and a destination port. The common data event format can further include a value for a corroboration level which can initially be set to zero.

The common data event database can include a threat model definition. The threat model definition can include one or more step definitions representing points in the threat model definition. A step definition can include content criteria that identifies a common data type and an activity to be analyzed. A step definition can also include an active activity threshold which can indicate a volume of activity required during a time period for a threat model step to be created and granted an initial status. A sustained activity threshold can also be included which indicates a volume of activity required during a time period for the threat model step to be granted a sustained status.

A threat model definition can comprise a first step, a second step, and a relationship definition which identifies a relationship and inheritance properties between the first step and the second step. A threat model definition can comprise a first step, a second step, and a relationship type which identifies data to be inherited from the first step by the second step. A source/destination switch indicator can also be included for switching destination information inherited from the first step by the second step to source information.

The invented system can also include an activity processor configured to receive device event data, translate the data into a common data event format, and store the translated data in the common data event database. The device event data is received from multiple devices which can use differing formats for reporting event data. The activity processor can be configured to read the differing formats and translate them into a common format. The activity processor can comprise an activity collector module for collecting the device event data from one or more sources, a common data dictionary which comprises mapping rules for converting fields of device event logs to a common data format, and a common data translator module for translating the collected device data into the common data format based on the mapping rules of the common data dictionary.

The threat model analysis engine of the present invention can generate a threat model instance corresponding to a threat model definition if a requisite volume of an activity defined in the threat model definition is met. The threat model instance can include a first state and one or more states representing a second step in threat progression for multiple targets identified in the activity corresponding to the first state. The threat model analysis engine can monitor the common event data for additional threat model instance related activity corresponding to the identified targets. In addition, the threat model analysis engine can monitor activity volume for a given step to determine if that step has occurred and/or is still occurring. Each threat model instance generated can include a unique identifier.

The invented system can also include an interface console for accepting threat model definition criteria from a user for creation of a threat model definition. The interface console can also be configured to demonstrate a threat model instance on a display.

### BRIEF DESCRIPTION OF THE DRAWINGS

FIG. 1 is a block diagram of a network personal computer that provides the exemplary operating environment for the present invention.

FIG. 2 is a block diagram of an exemplary network architecture and related security devices in which embodiments of the present invention can be implemented.

FIG. 3 is a block diagram illustrating one potential exemplary embodiment of computer architecture capable of hosting the present invention with illustration made of the flow of raw device activity data into the present invention.

FIG. 4 is a block diagram illustrating one exemplary threat model definition that can potentially be defined by a user of the present invention.

FIG. 5 is a block diagram illustrating an exemplary worm propagation behavior computer security threat.

FIG. 6 is a block diagram illustrating the possible structure and data of threat model states at one point in time, produced by the present invention.

FIG. 7 is a block diagram illustrating an exemplary software architecture of the present invention.

FIG. 8 is a logic flow diagram illustrating a threat model creation process.

FIG. 9 is a logic flow diagram illustrating an exemplary sub process or routine of FIG. 1 for identifying content criteria for a given point/step of a threat model definition.

FIG. 10 is a logic flow diagram illustrating the threat model analysis performed by the present invention.

FIG. 11A is a logic flow diagram illustrating an exemplary sub process or routine of FIG. 1 for serializing a defined threat model to persistent storage.

FIG. 11B is a diagram illustrating the type of information that can be managed relating to a threat model's general definition.

FIG. 11C is a diagram illustrating the type of information that can be managed for each point/step of a defined threat model.

FIG. 11D is a diagram illustrating the type of information that can be managed relating to each criteria for a given threat model step/point.

FIG. 12 is a logic flow diagram illustrating an exemplary sub process or routine of FIG. 10 for performing threat model analysis.

FIG. 13 is a logic flow diagram illustrating an exemplary sub process or routine of FIG. 8 for identifying the persistence or promotion type for a given threat model step using a chosen combination of attributes.

FIG. 14 is a logic flow diagram illustrating an exemplary sub process or routine of FIG. 12 for determining the maximum window of time data activity for each common type present for a specified company must be analyzed based on defined threat models.

FIG. 15 is a logic flow diagram illustrating an exemplary sub process or routine of FIG. 5 for retrieving the appropriate serialized states that require further analysis.

FIG. 16 is a logic flow diagram illustrating an exemplary sub process or routine of FIG. 12 for performing retrieving common data for analysis.

FIG. 17 is a logic flow diagram illustrating an exemplary sub process or routine of FIG. 5 for performing analysis on existing threat model states.

FIG. 18 is a logic flow diagram illustrating an exemplary sub process or routine of FIGS. 10, 11, 13, and 17 for performing activity analysis on a specified threat model state.

FIG. 19A is a logic flow diagram illustrating an exemplary sub process or routine of FIGS. 18 and 20 for applying an activity time promotion to a given threat model starting at the threat model state specified.

FIG. 19B is a logic flow diagram illustrating an exemplary sub process or routine of FIG. 18 for determining the window of time a point in a threat model has to meet its criteria.

FIG. 19C is a logic flow diagram illustrating an exemplary sub process or routine of FIG. 18 for assembling the content criteria used to identify applicable activity to a given threat model step in analysis.

FIG. 20 is a logic flow diagram illustrating an exemplary sub process or routine of FIG. 11 for performing activity analysis on a point that has already met active criteria in a given threat model.

FIG. 21 is a logic flow diagram illustrating an exemplary sub process or routine of FIGS. 11 and 13 for the identification of groups for branched analysis from activity that has met the criteria of a given threat model point.

FIG. 22A is a logic flow diagram illustrating an exemplary sub process or routine of FIG. 17 for the creation of a record representing the state of a given threat model's first point of analysis that has met active criteria.

FIG. 22B is a logic flow diagram illustrating an exemplary sub process or routine of FIGS. 11, 13, and 17 for the creation of a record representing the state of a given threat model beyond the first point of activity.

FIG. 23 is a logic flow diagram illustrating an exemplary sub process or routine of FIG. 11 for the process of identifying a given point in threat activity as having ended in its corresponding state's record.

FIG. 24 is a logic flow diagram illustrating an exemplary sub process or routine of FIG. 5 for the process of analyzing common data activity for new threat models.

FIG. 25A is a logic flow diagram illustrating an exemplary sub process or routine of FIG. 17 for the determination of the window of time which activity is analyzed for new threat model existence.

FIG. 25B is a logic flow diagram illustrating an exemplary sub process or routine of FIGS. 11 and 13 for the determination of the window of time which activity is analyzed for sustained threat model existence.

FIG. 26 is a logic flow diagram illustrating an exemplary sub process or routine of FIGS. 13 and 17 for performing customizable actions upon the occurrence of the last point in a threat model meeting active criteria.

FIG. 27 is a logic flow diagram illustrating an exemplary process for performing corroboration jobs.

FIG. 28 is a logic flow diagram illustrating an exemplary sub process of FIG. 27 for performing defined corroboration as part of a given step of corroboration strategy.

### DETAILED DESCRIPTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as an illustration, specimen, model or pattern. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

The present invention provides a threat model analysis framework that allows for the definition of threat models and ongoing identification and monitoring of their partial and complete existence in security data. The invention can translate heterogeneous data provided by disparate sources to common data formats and provide translated data for analysis using definable threat model definitions.

The analysis engine is able to identify new points of threat activity of a threat model, and also perform persistent analysis and tracking of ongoing threat model points of existence. In definition and reporting, points of threat models are grouped based on their distance from the first point of a given threat model and referred to as steps.

Upon the detection of threat model points of existence, the threat model analysis engine can be triggered to perform additional analysis for multiple identified points of potential threat progression. In addition, persistent analysis updates to any existing point of threat model occurrence provides the capability of triggering the threat model analysis engine to perform additional analysis for any newly identified points of potential threat progression.

Translated data provided for analysis can comprise ongoing threat data, privacy data, border data, system data, assessment data and/or any other common security data type regardless of type and vendor. This is made possible by the common data format framework utilized for threat model definition and during interpretation of data provided in analysis.

The resulting information produced by the threat model analysis performed by the present invention is able to be displayed in an organized fashion to effectively demonstrate the threat model it describes. Such a display can include both the device activity related to the threat's occurrence over time and the relationship of individual events with each other and their environment.

The present invention can be embodied in software that can be distributed across multiple systems, based on data and process load requirements. The present invention can comprise a computer security analysis system which provides console access for the management of custom security threat models. The invented system can retrieve, interpret, translate data to common security data types, and analyze stored common security data from one or more locations for threat model activity. Additionally, the invention can track points in threat models as they occur in ongoing data activity, and store detailed information for their dynamic reconstruction in presentation to one or more consoles. The analysis system can also identify activity required for corroboration according to policy items that are customizable through the console. In addition, the present invention can also comprise a computer service which can execute corroboration strategies on data identified by the analysis system based on the policy for which each data item is identified. Results from corroboration strategy execution can be stored for reuse in analysis and also for display in one or more consoles.

Illustrative Operating Environment

In describing embodiments of the present invention illustrated in the drawings, specific terminology is employed for the sake of clarity. However, the present invention is not intended to be limited to the specific terminology selected, and it is to be understood that each specific element includes all technical equivalents.

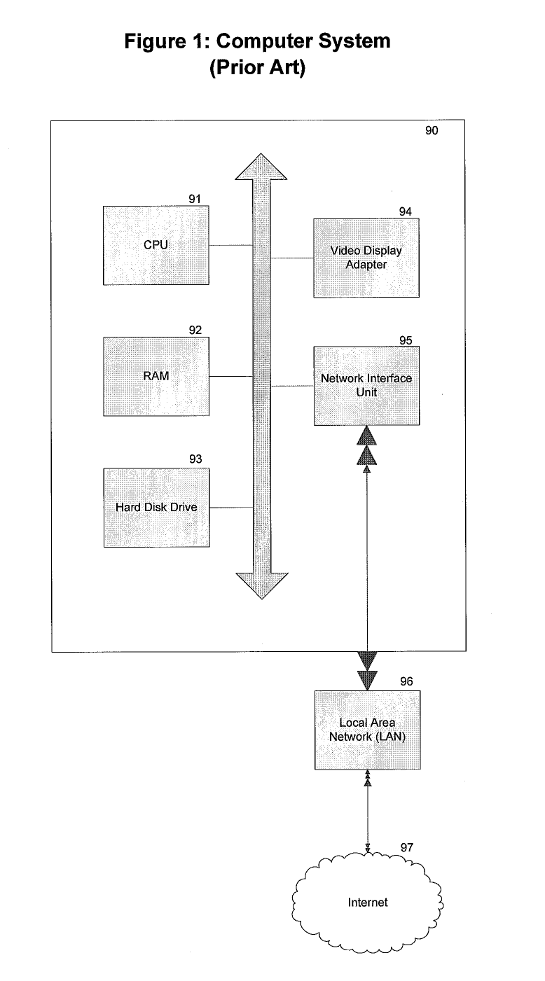

FIG. 1 shows an example of a computer system capable of implementing the system and method of the present invention. The system and method of the present invention can be implemented in the form of a software application running on a computer system, for example, a mainframe, personal computer (PC), handheld computer, server, etc. The software application can be stored on a recording media locally accessible by the computer system, for example, compact disk, hard disk, etc., or can be remote from the computer system and accessible via a hard wired or wireless connection to a network.

The computer system, referred to generally as System 90, can include a central processing unit (CPU) 91, memory 92, for example, Random Access Memory (RAM), a data storage device, such as a hard disk, 93, a video display adapter 94, and a network interface unit 95, which can be connected to a Local Area Network 96 and/or the Internet 97.

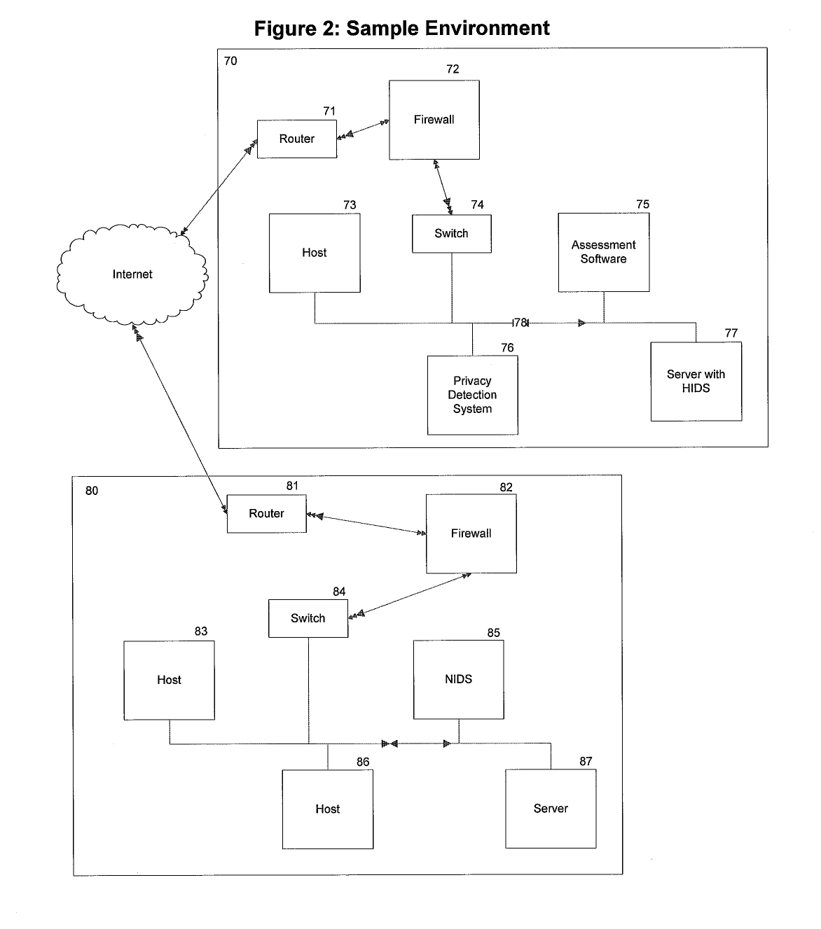

FIG. 2 shows examples of the types of systems in which embodiments of the present invention can be implemented. The embodiment shown includes a plurality of networks 70, 80, although those skilled in the art will recognize that the present invention can be implemented in both a distributed and stand-alone fashion. Network 70 includes one or more general client computers 73, one or more firewalls 72, one or more security assessment software implementations 75, one or more privacy detection device implementations 76, one or more routing or switched network implementations 71, 74, and one or more host-based intrusion detection software implementations 77, which are interconnected via any type of network connection 78.

Network 80 can include one or more routing or switching devices 81, 84, one or more firewalls 82, one or more hosts 83, 86, one or more servers 87, and one or more network intrusion detection systems (NIDS) 85.

Both border infrastructure (71,81,72,82) and sensor infrastructure (76,77,85) can be any type of system capable of performing data collection functions and producing related logs. Similarly, other items depicted in FIG. 2, including switches, routers, servers, and hosts can also be used as sources for the present invention if they log pertinent activity, such as system, application, or traffic related activity, etc. The present invention is not limited to the types of data sources illustrated. Any source of information capable of providing normalized activity or other related security data can be utilized for threat model analysis. This can also include human sources of information, which can be normalized on input, such as investigative results done by personnel, etc.

Exemplary Computer Architecture

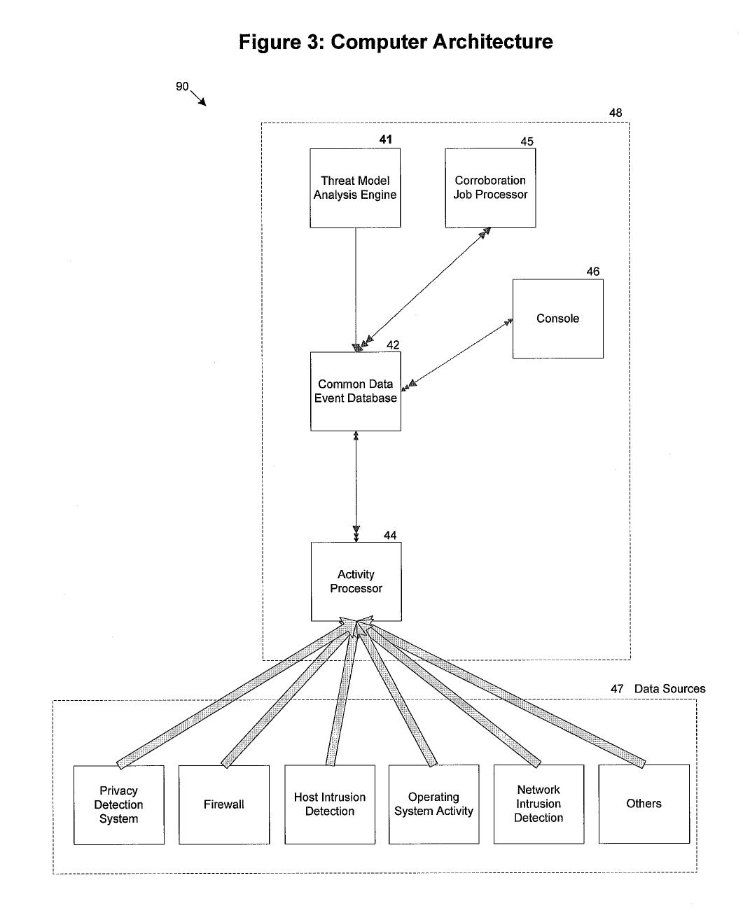

FIG. 3 illustrates one exemplary embodiment of computer architecture of a system 90 according to the present invention. The security system 90 can comprise an Activity Processor 44 that is linked to a Common Data Event Database 42. The analysis system can also comprise data sources 47 that are linked to the activity processor. The Activity Processor can comprise a mechanism for retrieving or receiving data from the data sources 47. In addition, the Activity Processor 44 can comprise a number of dictionaries and mechanisms to identify, organize, and translate device data to common data formats before serialization to the Common Data Event Database 42.

The security system 90 can further comprise a Common Data Event Database 42 that is linked to the Activity Processor 44, a console 46, the Threat Model Analysis Engine 41, and the Corroboration Job Processor 45. A “time window of activity” for each type of common event data will typically be loaded and maintained in the Threat Model Analysis Engine 41, which can comprise fast access memory for quick analysis. Memory resources can be designed based on the activity window sizes specified in the threat models' definitions created by the system users.

The data sources 47 can comprise any device, whether software or hardware, that is a source of pertinent activity, whether operational activity, such as system or application activity, or other activity related to security. The present invention is not limited to the types of data sources illustrated. The function of the data sources 47 is to provide information to the activity processor as it relates to risk, threat, or general operation activity.

The activity processor 44 can comprise one or more program modules designed to receive or collect data from the data sources 47. The activity processor can include one to many dictionaries which can be used to both map data items from sources to common data types and to add pertinent attributes related to one or more knowledge bases. The knowledgebases can be proprietary or provided by user input. One knowledgebase dictionary can comprise information necessary to cross reference common device information, such as threat or risk activity, between device vendors. Another knowledgebase can comprise information necessary to identify the data owner of messages received, such that information can be segregated for storage and possibly access.

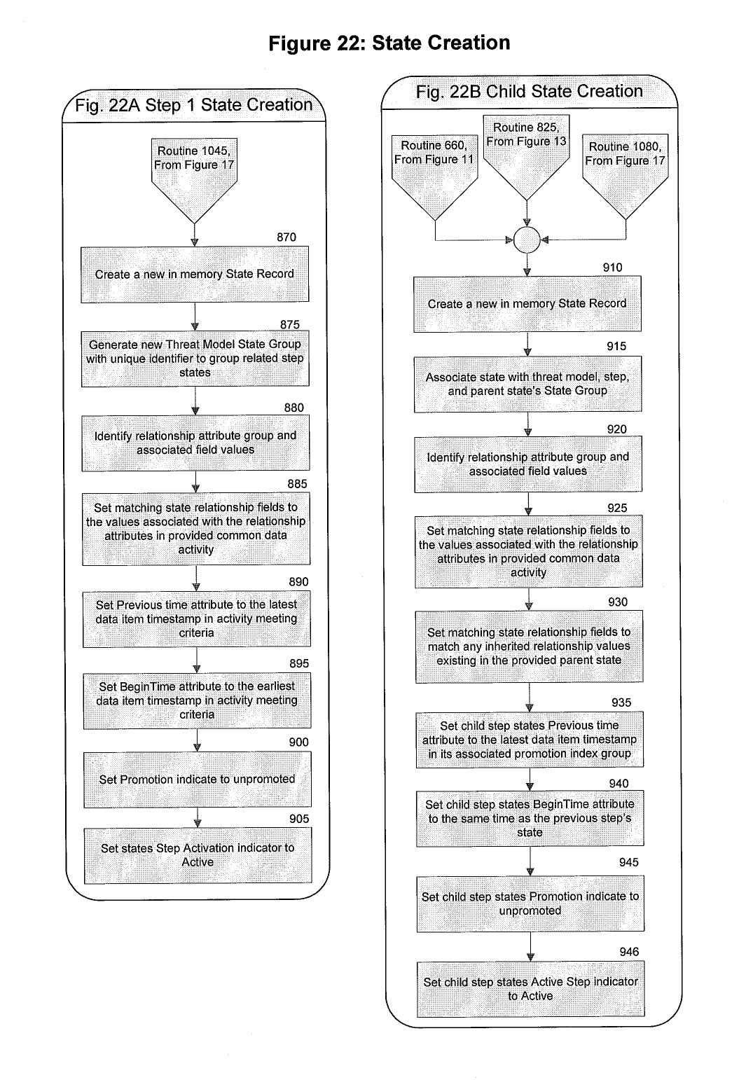

The security system can comprise one or more threat model analysis engines 41, distributing the analysis load based on data owner or threat model definitions. Results from the analysis can then be serialized with the information described during creation in FIG. 22, to the Common Data Event Database 42.

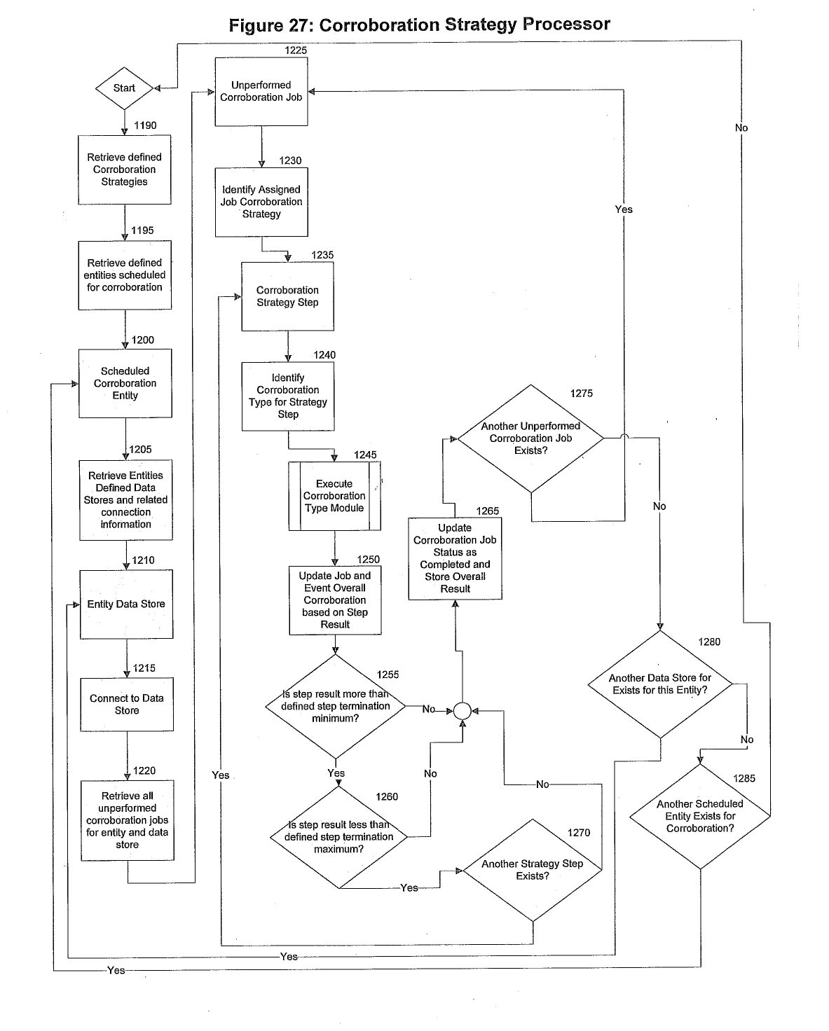

The security system can comprise one or more corroboration job processors 45, which can distribute the analysis load based on data owner or corroboration strategy. As shown in FIG. 27, corroboration is performed per scheduled corroboration entity, FIG. 27 at block 1200, which can allow the distribution of corroboration jobs to be distributed by scheduling different entities, which can refer to companies, divisions, data owners, etc., across multiple instances of the Corroboration Job Processor. Results from the corroboration can then be serialized to the Common Data Event Database 42.

The Console 46 can comprise a program module with the ability to retrieve analysis information from the Common Data Event Database 42, as serialized by other components, for organized reporting.

The Activity Processor 44, Common Data Event Database 42, Threat Model Analysis Engine 41, Corroboration Job Processor 45, and Console 46 have been circumscribed by a box 48, to demonstrate that each of these components can be implemented on a single machine. However, the present invention is not limited to this configuration. One or more of each component can be utilized to distribute work load, segregating work based on work item, data owner, or the locale of the data source. Additionally, one skilled in the art will recognize that other software architectures than the architecture illustrated in the enclosed drawings is possible without departing from the scope of the present invention.

Exemplary Data Translated by the Activity Processor

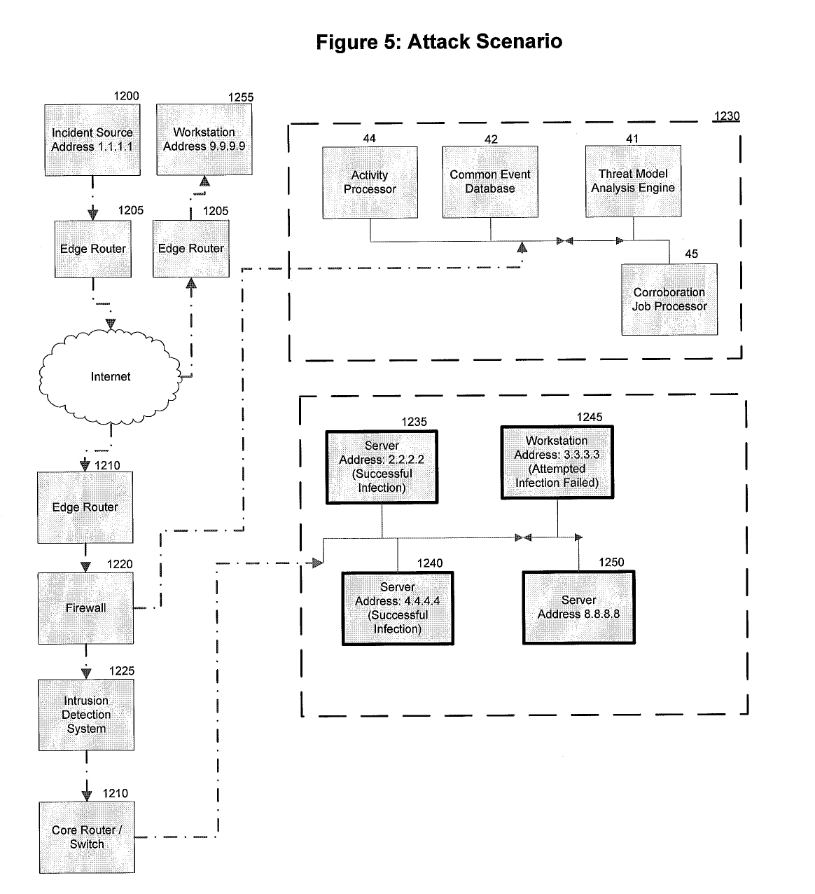

FIG. 5 illustrates the flow of between components of the security system and its sources through the exemplary computer architecture in an attack scenario. Data starts at the data sources, which can include a firewall, 1220, edge router, 1210, Intrusion Detection System, 1225, or other data providing component. The raw data produced by configured devices is collected by the Activity Processor 44, which is connected to a Common Data Event Database 42. The Common Data Event Database 42 is further connected to a Threat Model Analysis Engine 41, Corroboration Job Processor 45, providing a central data source to these components and can further comprise knowledgebases for their processing. Data collected from the data sources by the Activity Processor 44 is shown occurring during the course of a worm security threat event. The incident source 1200 can be comprised of a single computer or a network of computers and can be connected to the Internet or local area network location with a network communication path to the targets.

Each of the device data sources show communication back to the Activity Processor 44. Communication can be achieved via physical data lines, wireless communications, or any other operable network link to the Activity Processor 44.

Referring again to FIG. 5, this diagram illustrates an exemplary raw event that is generated by an intrusion detection device. In addition, FIG. 5 illustrates an exemplary event that can undergo processing. The processing of device data related to an event is also referred to as translation in this disclosure. The device event data can comprise a message including a source Internet protocol address, a delimiter, and a source port.

Similarly, the device event data can comprise a message including a destination Internet protocol address, a delimiter, and a destination port. The data provided by any of the data sources illustrated in FIG. 5 is extracted and then mapped via common data dictionary information to a common data event. Additional items may also be identified and added to a given common data event, such as the owner of a given device data event for segregation of data or access. Additionally, in order to provide vendor and overall source neutrality, some device data items can be universalized, such as an intrusion detection system's given attack signature associated with a given event. Also, other common event data as provided by either proprietary or custom knowledge bases can be also added. The resulting data, referred to herein as “common data” or “common event data” is then utilized by the other components of the system to provide functionality on data that is considered translated and enriched by associated knowledgebases.

One who is skilled in the art will recognize that other forms of information pertinent to a data owner or its business, or logistical environment and capable of being associated with common event data can be pertinent and useful in the present invention's methodology of analysis. As will be discussed further below, common data events also contain a corroboration level, starting with a zero knowledge value, and later updated to appropriate information during corroboration job processing. Processing of device event data for translation to common event data is not limited to that which is illustrated.

Threat Model Definition

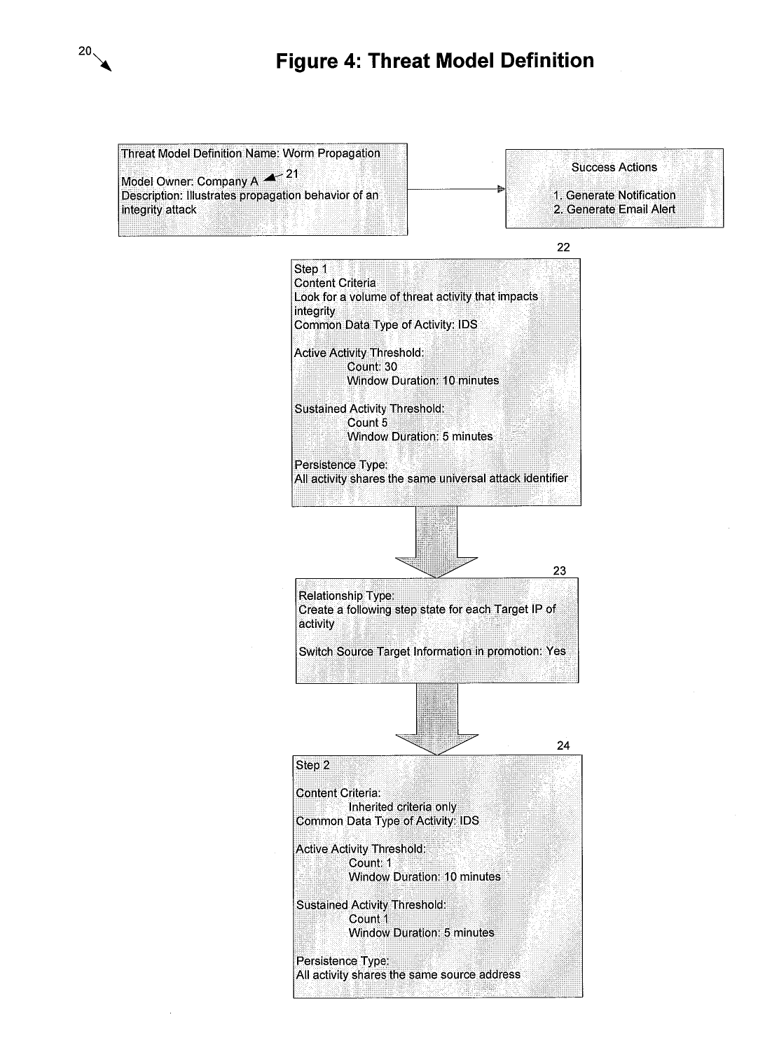

Referring now to FIG. 4, this Figure illustrates one exemplary threat model definition that can be defined by a user of the present invention for analysis. The threat model definition 20 can comprise general descriptive information 21. General descriptive information 21 can comprise a name for the threat model and a specified owner or author of the definition.

Additionally, the model definition can comprise one or more Step definitions 22, 24, representing steps in activity as a threat progresses that is being defined. Each step definition can include content criteria. The content criteria identify the common data type and one or more criteria that identify the activity of interest for purposes of analysis. A step definition can include an Active Activity Threshold, which represents a volume of activity satisfying given content criteria that is required during a given period of time (window duration) for the threat to be granted initial status. A step definition can also include a Sustained Activity Threshold, which represents a volume of activity satisfying given content criteria that is required during a given period of time for the threat to be granted a sustained status. A step definition can also comprise a persistence type which identifies one or more data fields or attributes required to be shared by each activity meeting the content criteria of the threat model for those activities to be considered part of a common threat.

Each combination of steps can also include a relationship definition 23 which identifies the relationship and inheritance of data between those steps. Additionally, each pair of sequential steps can also include a relationship type, identifying which fields of data will be inherited for criteria from one step to the next for data analysis and potential branching. The relationship type effectively “relates” data in each point of the threat model to the one or more following points of the threat model. In addition, for steps having a following step and where the relationship type specifies the source and/or target to be inherited by the following step, a source/destination switch indicator can be used. The source/destination switch indicator can permit the source and destination information chosen for inheritance to the next step of analysis to be switched in the following step. This allows, for example, the target of activity in step one to be analyzed as being the source of some activity in the following step.

Exemplary Threat Model Analysis and Results

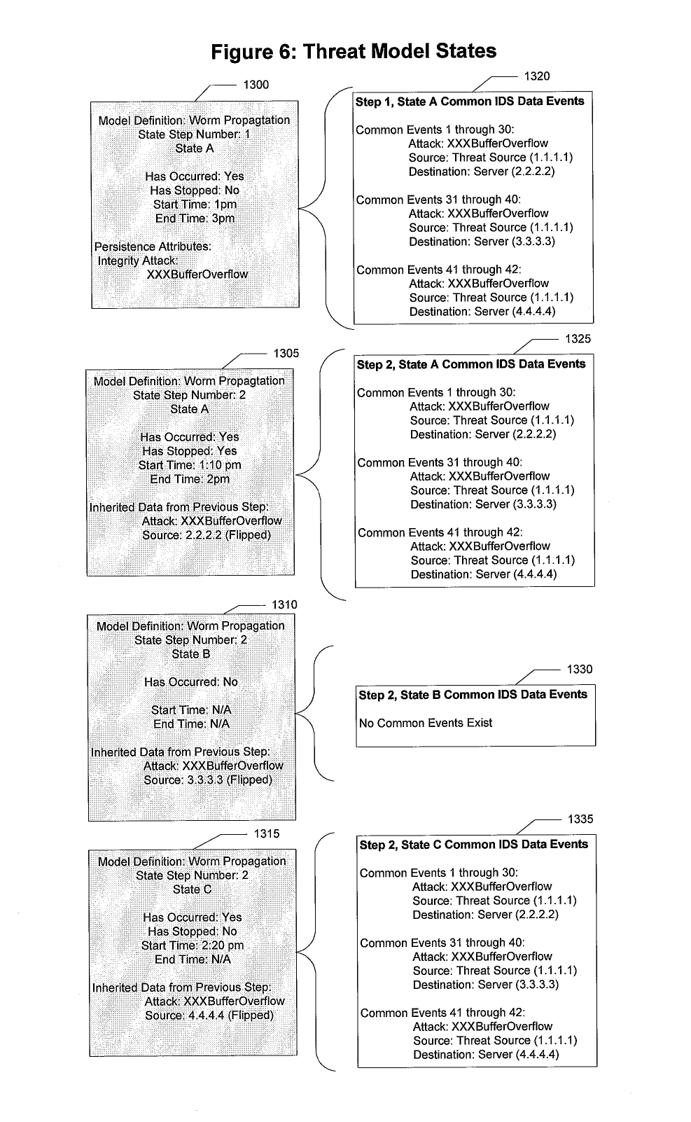

Referring now to FIG. 5, this figure is a block diagram illustrating an exemplary attack matching the example worm propagation threat model definition described above. FIG. 5 illustrates an incident source 1200 with an Internet protocol address of 1.1.1.1 sending a volume of attack activity to multiple computer targets including: Server 1235 with an Internet protocol address 2.2.2.2, Workstation 1245 with an Internet protocol address 3.3.3.3, and Server 1240 with an Internet protocol address 4.4.4.4. The common data activity translated when received from sensor devices can comprise the common data events described in step 1 shown in the threat model states of FIG. 6. The sensor devices can comprise the Firewall 1220, the Intrusion Detection System 1225, or any of the targeted servers or workstations. Upon compromising two of the targeted hosts of activity, Server 1235 and Server 1240, these two hosts proceed to send the same attack to other hosts. The Server 1235 at Internet protocol address 2.2.2.2 sends the same attack to Server 1250 at Internet protocol address 8.8.8.8. The Server 1240 at Internet protocol address 4.4.4.4 sends the same attack to Workstation 1255 at Internet protocol address 9.9.9.9. The Workstation 1245, although also a recipient of the original attack from the threat source 1200, does not send the same attack to other hosts potentially because it was not vulnerable to the attack or other reasons.

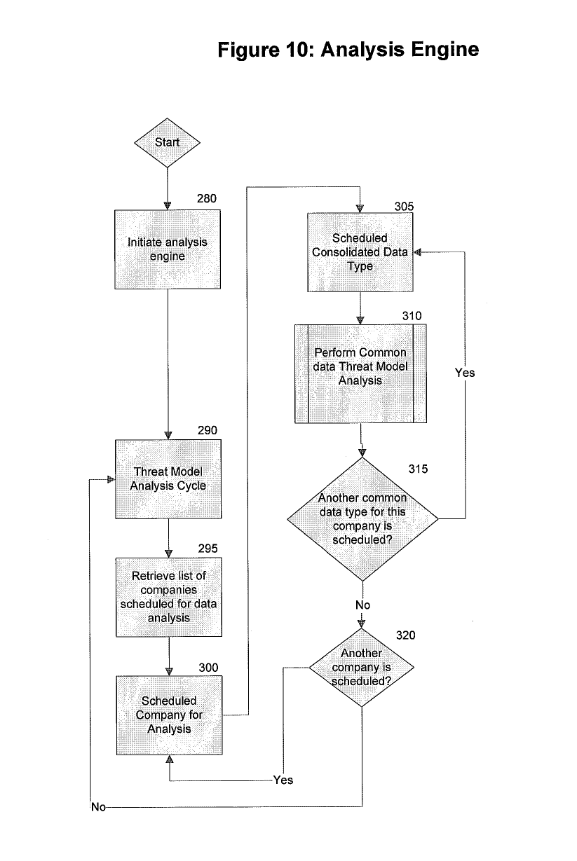

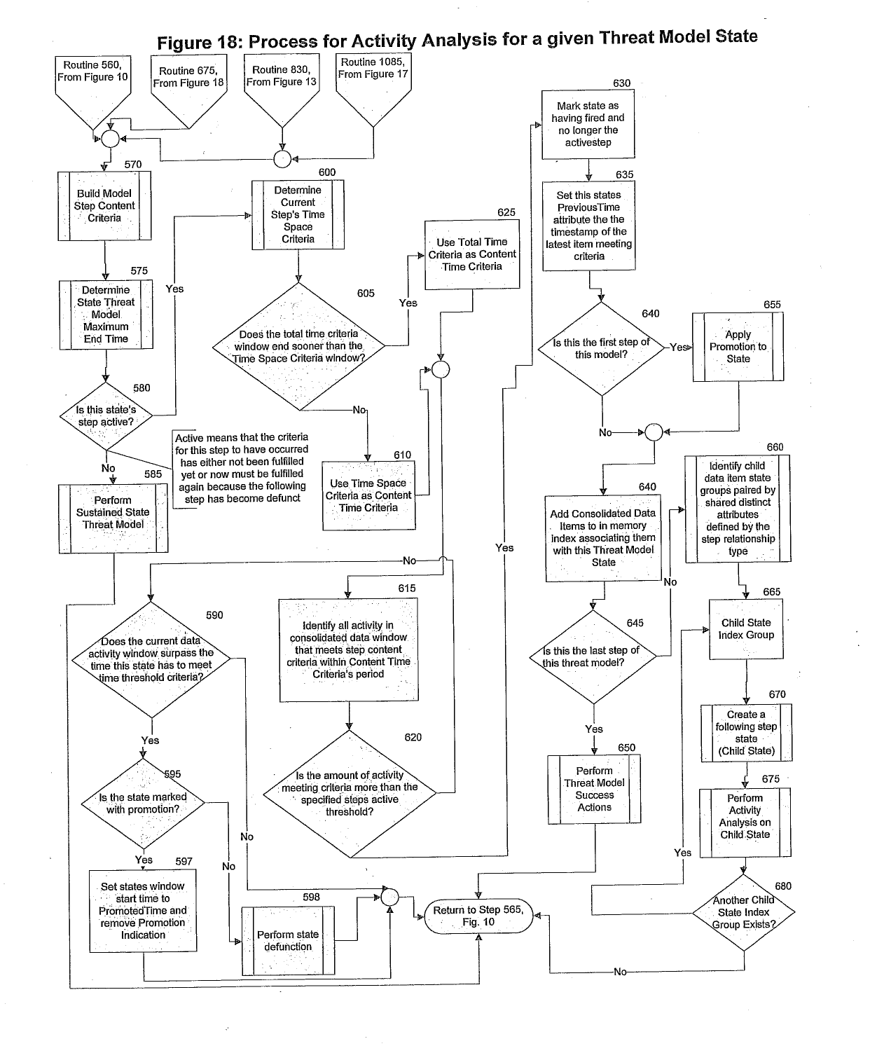

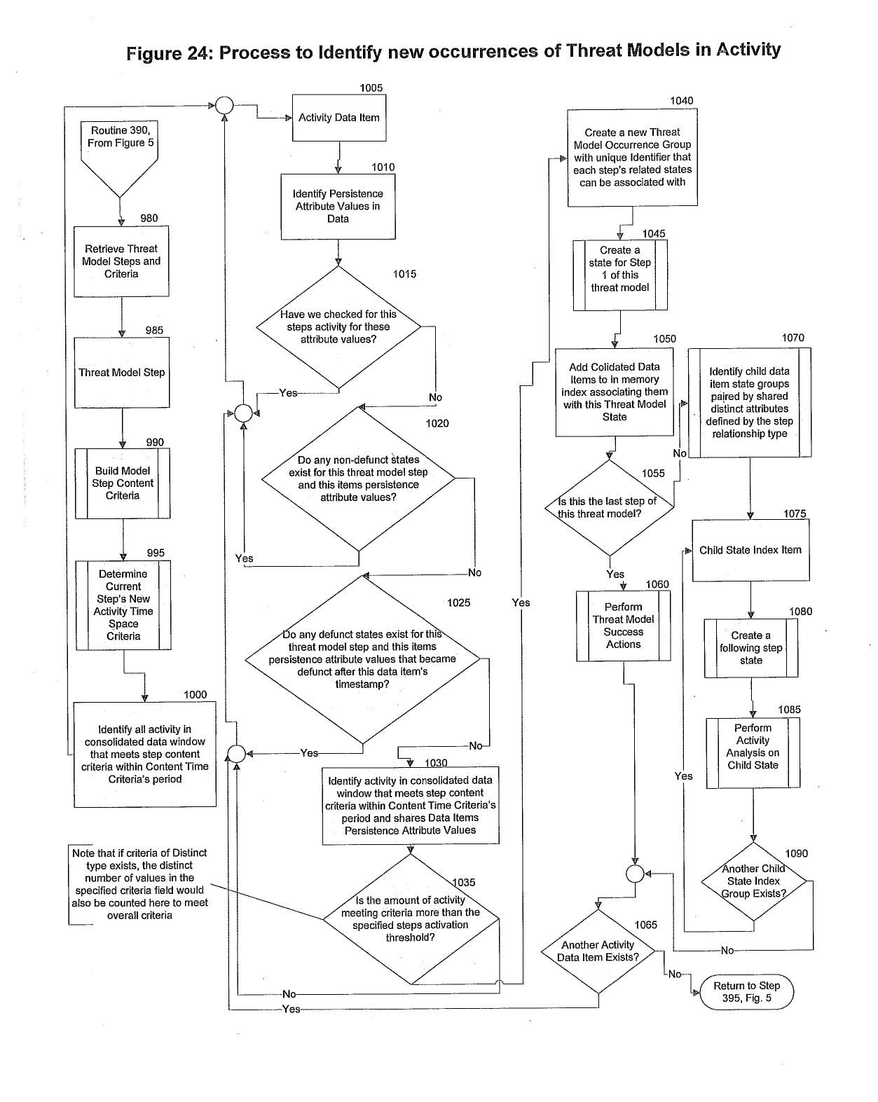

Upon creation of the threat model described in FIG. 6 (corresponding to the threat model definition of FIG. 4), the threat model analysis method loads the definition into memory to be part of its real or near real time common data analysis. Detected events that are related to the initial attack made by the threat source at internet protocol address 1.1.1.1 are received and processed by the activity processor. These events are then loaded into the Threat Model Analysis Engine 41. Upon the analysis engine detecting the existence of the elements necessary to meet a threat model definition (in this case, the worm propagation model shown in FIG. 4), the threat model analysis engine generates a threat model corresponding to that threat model definition. In the case of the present example, the requisite volume of activity for the worm propogation threat model definition is detected, where the activity shares the same source Internet protocol address of 1.1.1.1 and the same attack XXXBufferOverflow. The threat model analysis engine generates a worm propagation threat model. The beginning point of the threat model is shown in FIG. 6 at 1300. Points in the threat model are referred to as states. The threat model analysis engine also stores references to the associated common data activity in its memory index. The analysis engine then creates a step 2 state for each of the distinct targets within the step 1 activity, including Internet protocol addresses 2.2.2.2, 3.3.3.3, and 4.4.4.4. The analysis engine then examines common data activity with regard to the step 1 activity volume to identify its continuance status and sustained active status in the threat model. In addition, the analysis engine can monitor common data activity for each of the given step 2 states to determine if these targets have become sources of the same activity. In the case of the Server 1235 and Server 1240 of FIG. 5, activity is found within the required time period that meets step 2 criteria. In the case of the Workstation 1245, no activity meeting step 2 criteria is found. The resulting states created by the analysis process each represent a point in the threat model occurrence and are capable of being used to construct an illustrated threat model such as the one demonstrated in FIG. 6. Further details of the processing performed by the threat model analysis engine will be discussed in more detail below with respect to FIG. 10. More specific details related to the processing performed by the threat model analysis engine to identify new threat models by their step 1 definitions will be discussed below with respect to FIG. 24. Details related to the processing of activity beyond the first step of any given threat model and the processing of previously identified activity corresponding to any step of a given threat model are discussed below with respect to FIG. 18.

FIG. 6 illustrates the possible data which can comprise a threat model. The threat model can comprise of one or more records, each representing a given fulfilled or unfulfilled point in the threat model, referred to as a state. Each state record can comprise identification of the threat model definition met by the detected activity and the specific occurrence of the threat model the activity is associated with, (as there can me more than one attack meeting a given threat model definition.) Each state record can further be comprised of an indication of whether or not the activity corresponding to the state has occurred, in addition to a start and ending timestamp of the activity if it has occurred (or is still ongoing). A state can also comprise a list of the common data activity items associated with it meeting the threat model definition's criteria, illustrated in blocks 1320, 1325, 1330, 1335.

If a previous point in the threat model exists relative to a given point, the state record can also comprise of one or values relating that step to the previous step of its threat model. This information can be used in analysis as part of criteria that is inherited from a previous threat model point. A state record can comprise other values as well, including whether or not a state has been promoted. Promotion of a state comprising a first point of a threat model can occur when and if the state meets its own criteria. Promotion of a given threat model point can also occur where a previous related threat model point meets it's state criteria. Promotion indication is used by the present invention as part of its methodology for increasing the amount of time a given threat model point's described activity is monitored as a result of the success of previous related points in the same model's occurrence. In the case of the first point of any threat model, this indicator is also used to increase the amount of time its own activity is monitored as a result of its own success, as this point has no previously related point in the model. This is illustrated in FIG. 6 by the inherited data shown in each of the step 2 states illustrated by blocks 1305, 1310, and 1315. In FIG. 6, two of the step 2 threat model points are shown as having met step 2 criteria, meaning that common data activity was detected related to the same attack. The attack in this case has a source internet protocol address matching the appropriate inherited attack identification, XXXBufferOverflow, and target internet protocol address from the previous step (2.2.2.2 in the case of State A 1305, and 4.4.4.4 in the case of State C 1315.) State B 1310 shows that the activity corresponding to the state was not detected from its inherited source internet protocol address of 3.3.3.3. Other values required for persistent analysis can exist and are detailed in further detail below with respect to FIG. 18.

The exemplary threat model definition illustrated in FIG. 4, the exemplary attack scenario illustrated in FIG. 5, and the exemplary threat model results in FIG. 6 are merely examples of the possible threat model definitions, related attack scenarios, and results that can be defined and analyzed by the threat model analysis engine 41. Other types of security threats are within the scope of the present invention. Those skilled in the art will appreciate the present invention is not limited to the exemplary common data events or represented states illustrated.

Exemplary Software Components of the Threat Model Analysis Engine

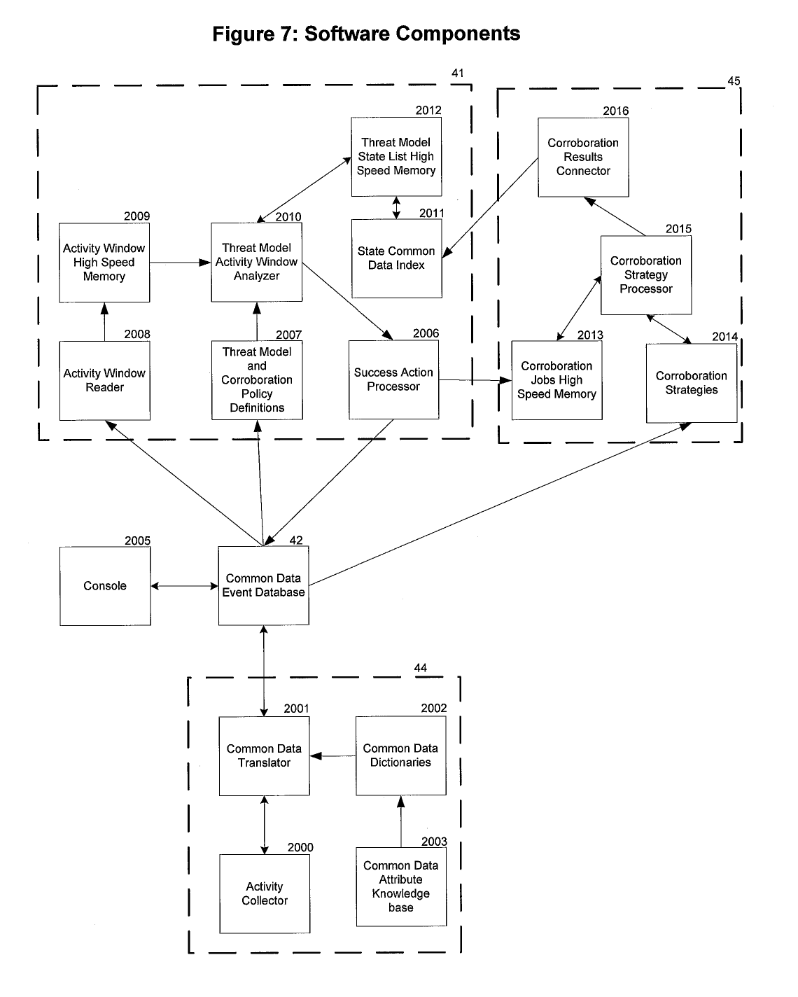

FIG. 7 is a block diagram of showing logical components of the activity processor 44, threat model analysis engine 41, and corroboration job processor 45. The present invention can be embodied as a computer program including the functions described in the appended flow charts. However, one skilled in the art will recognize that the present invention can be achieved in many different implementations of computer programming and is not be limited to any one set of computer instructions. The logical functionality of the present invention will be explained in more detail below with reference to the remaining figures of illustrative logic flow.

The security system can be implemented in an object oriented programming design. Therefore, each software component illustrated in FIG. 7 can comprise data and/or code.

As illustrated in FIG. 7, the activity processor can comprise an Activity Collector 2000 capable of receiving or actively collecting activity data from any number of devices. Data that is collected can then be given to the Common Data Translator 2001 for translation. The Common Data Translator 2001 can typically load information required for translation from the Common Data Dictionaries 2002 upon initialization. Data dictionaries can include lists associated with the data received from the Activity Collector 2000 which facilitate translation of data from various devices to common formats. Additionally, data loaded from the Common Data Attribute Knowledgebase 2003 can comprise one or more lists associated with common data format values. During translation, it is the job of the activity processor to collect and translate data received into a common data format and, in some cases, attach attributes related to common data events that are identified in the Common Data Attribute Knowledgebase 2003. The Common Data Translator 2001 can then serialize Common Activity Data to the Common Data Event Database 42.

The Common Data Event Database 42 can also include reference information, including threat model definitions and corroboration strategies defined by users. Threat model definitions can be retrieved during initialization of the threat model analysis engine 41. This retrieval is illustrated by the communication illustrated from the Common Data Event Database 42 to the Threat Model and Corroboration Policy Definitions 2007 in the threat model analysis engine 41. In addition, Corroboration Strategies 2014 can be retrieved from the Common Data Event Database 42 during initialization of the Corroboration Job Processor 45. Notifications related to the Success Action Processor 2006 can also call for other data to be serialized to the Common Data Event Database 42 such that that component should not be construed to be limited in providing or storing the information illustrated.

The Activity Window Reader 2008 can be responsible for determining and retrieving a window in time of common activity data and storing this data in Activity Window High Speed Memory 2009. The Threat Model Activity Window Analyzer 2010 can then be responsible for analyzing the Common Data Activity, maintained in the Activity Window High Speed Memory, 2009, continuously in time.

The Threat Model Activity Window Analyzer 2010 can also be responsible for retrieving Threat Model Definitions, 2007, during initialization or as necessary based on the common data owner(s) of data being analyzed. Threat model definitions can comprise the components illustrated in FIG. 4. The Threat Model Activity Window Analyzer 2010 tracks common activity data received and stores state information related to identified points of threat models in the Threat Model State List High Speed Memory 2012. The Threat Model State List High Speed Memory 2012 can also be responsible for storing reference information to common data events associated with the states that it warehouses. Upon any point in a threat model meeting defined criteria, one or more potential success actions can be performed. Therefore the Threat Model Activity Window Analyzer 2010 can be responsible for notifying the Success Action Processor 2006 upon success and failure of activity associated with threat models.

The Success Action Processor 2006 can be further responsible for performing configurable actions which can involve the storage of information in the Common Event Database 42. The Success Action Processor 2006 can be further responsible for creating corroboration jobs as result of discovering threat model activity identified as part of corroboration policy.

The Corroboration Job Processor can be responsible for corroboration strategies, which detail the execution plan for corroborating common data activity specified in the Corroboration Jobs High Speed Memory 2013. The results from corroboration of common data activity can be delivered to the Corroboration Results Connector 2016. The corroboration results can include both the sum and individual results of corroboration strategy steps from their execution by the Corroboration Strategy Processor, 2015. The Corroboration Results Connector 2016 can be responsible for forwarding corroboration results as updates to the State Common Data Index 2011 to be used in threat model analysis.

The Console, 2005, can be responsible for retrieving and intelligently displaying threat models and corroboration results serialized in the Common Data Event Database 42.

Computer-Implemented Process for Threat Model Definition

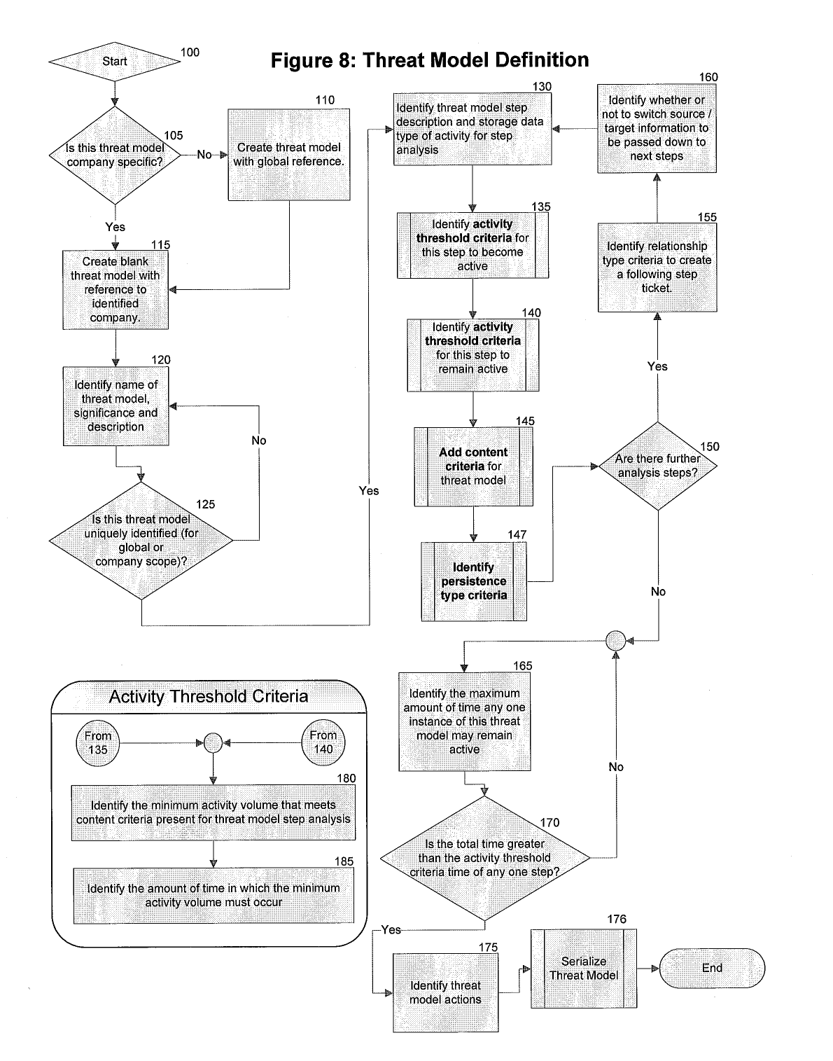

Referring now to FIG. 8, this logic flow diagram represents a user interactive process for creating a threat model definition for analysis. This process can comprise a series of questions and related structured storage of information attained from the user. This process can start at block 100 and proceed to block 105 asking the user to identify a specific entity on behalf of which analysis should be performed. The user can be given the option of performing analysis on data the entity specifically maintains ownership of (processing would continue to block 115) or performing the defined threat model analysis for all entities known to the system (where processing would continue to block 110). The model definition interface can then create a blank threat model definition structure for storage that is associated with all entities or one specific entity for ownership based on the user's selection at block 115. The user can then be asked to identify a unique name and description for the threat model which can be used to identify and describe its occurrence at block 120. The information provided for the threat model name and description can then be tested to ensure its uniqueness as a form of validation at block 125, and request that the user make appropriate changes if it is not determined to be unique. The user can then be presented with a method for entering information defining a step in the threat model at block 130. More specifically, the process of defining a step can involve entering a description of the activity the step looks for and the common data type of activity to be examined in analysis by this step. The user can then be asked to enter information concerning the volume and time window during which the described step activity is required to occur to meet the criteria for step occurrence at block 135. The user can then be prompted to enter information concerning the volume and time window during which the described step activity is required to occur for any given point of occurrence to be considered as continuing to occur at block 140. Both the definition of active (block 135) and continued (block 140) time criteria can comprise the identification of the requisite volume of activity meeting content criteria (see block 180) and the amount of data source activity time (time window) during which the described volume must be identified (see block 185). The user can then be asked to provide content criteria, at block 145, identifying the specific details to be used as criteria in analysis of the data—specifically identify the data relating to the described step's activity. The user can then be given the option to identify one or more attributes in the described data that are required to share the same value in any one point of occurrence of the given step, referred to as the persistence type criteria, at block 147. The attributes presented for these criterion/criteria can be based on the available attributes present in data of the step's identified common data type of activity for analysis. The user can then be presented with the option of identifying a following step in the model of threat activity at block 150.

If the user chooses to identify a following step in the threat model, they will be asked to describe the relationship between activity occurring in the current step and the following step to be defined at block 155. This relationship can comprise one or more data attributes that the system can use as content criteria for both the common data type of the current step and the following step of threat model activity. The described relationship can later be used to determine the number of unique related states to be created for the following step of the threat model for analysis. The unique related states represent each of the distinct values or value combination of attributes identified by the relationship type. The user can then be given the option to switch the source and destination attribute values in the relationship type for the following step in threat model analysis at block 160. This option to switch the source and destination attribute can be used to control the direction the given threat activities flow in analysis criteria. The user can then be returned to the previously described steps to describe a threat model step (back to block 130) for description of the following step in analysis.

If no further steps are chosen to be defined for the given threat model at block 150, the user can be asked to designate total amount of time that they wish for any distinct occurrence of the described threat model to be analyzed before each related state will have its activity status marked as inactive and cease to be analyzed at block 165. This amount of time can be validated at block 170 by verifying that the amount of time given for any occurrence of the described threat model as a whole (at block 165) is greater than or equal to the amount of time any given step of the model has to meet its defined time related activity (see block 135). If validation fails, the user can be asked to make appropriate changes to their total time criteria. Upon successful validation of total time criteria entered at block 170, the user can be given the option to specify one or more actions to be taken by the system upon the occurrence of any threat model meeting all or some steps of criteria in analysis at block 175.

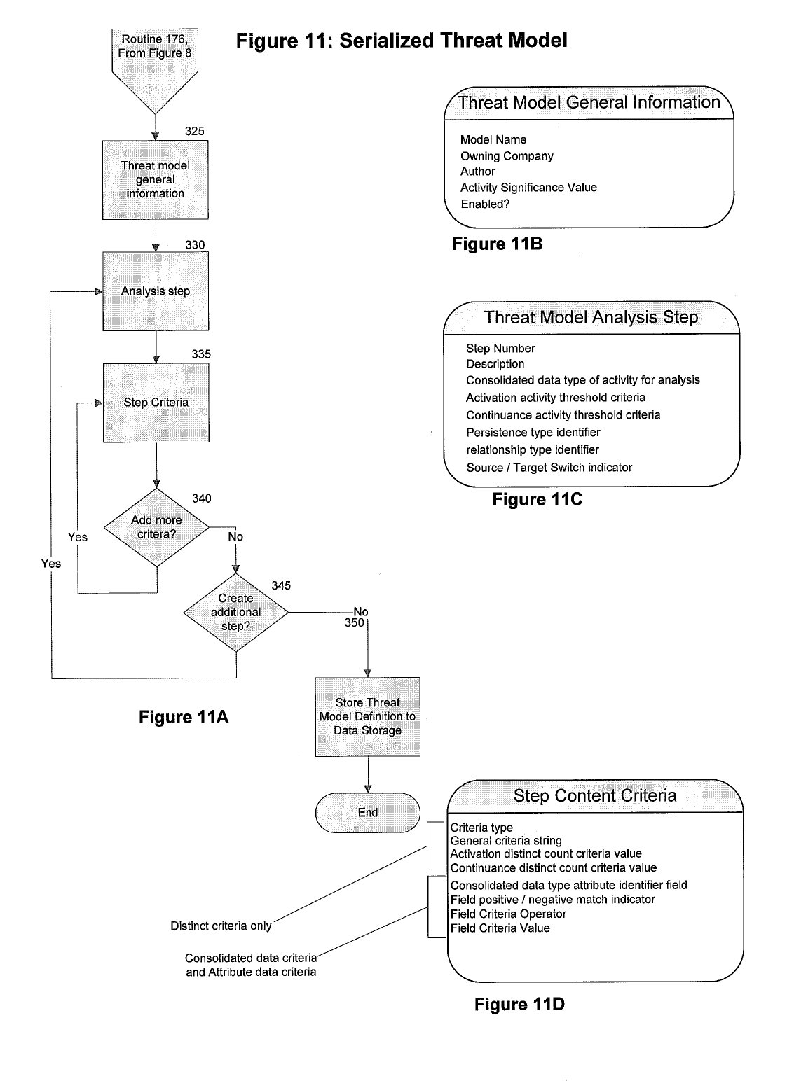

Once defined, a threat model definition can be serialized at block 176, as described below with regard to FIG. 11A.

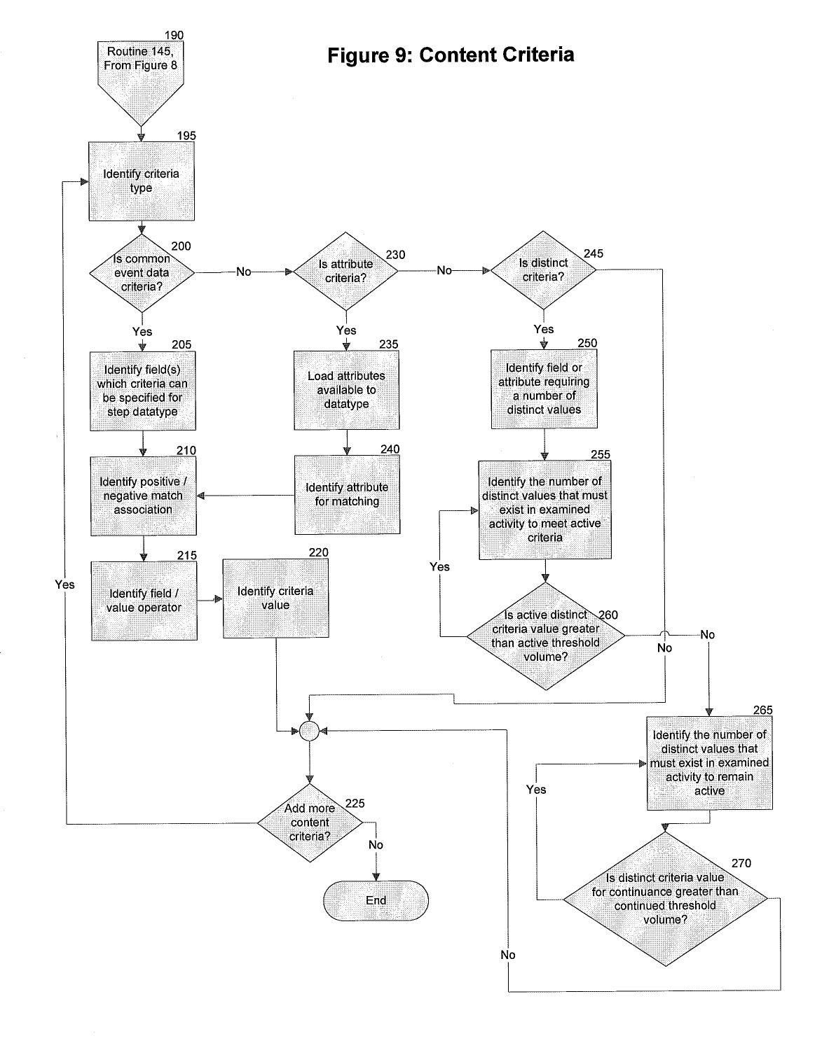

Referring now to FIG. 9, this figure illustrates the exemplary logic flow of defining content criteria in a threat model definition. The method begins at block 190. This process is prompted during the threat model definition process, as illustrated in FIG. 8, block 145. During content criteria definition, a user can be asked to specify the type of content criteria they wish to add to the given threat model definition step at block 195. This type of content criteria can be then tested against criteria types known by the present invention for analysis, consisting of common event data criteria, (processed at block 200), attribute criteria (processed at block 230), and distinct criteria (processed at block 245).

If common event data criteria is chosen by the user, the user can be presented with a list of attributes available in the identified threat model step's common data type for analysis. The user can choose the common data type attribute for which they wish to specify criteria at block 205.

If attribute data criteria is chosen by the user, a structured list of attributes related to the specified common data type of the threat model step can be loaded and presented to the user at block 235. The user can then be prompted to specify the attribute for which they wish to add criteria at block 240.

Upon common event data or attribute field choice, the user can then be asked whether the described criteria should be tested for explicit presence or non-existence in analyzed data activity to meet criteria at block 210. The user can then be requested to specify an applicable test operator to use in comparing the value found in the specified attribute or common data field at block 215. The operators given for choice can be dynamically determined based on the type of data and value choices available to the given field. The user can then be requested to specify the criteria value at block 215 for which analyzed data will be compared to using the identified comparison operator.

If distinct criteria is chosen (processed at 245), the user can be presented with a list of common data fields and/or related attributes available for the threat model step's specified common data type. The user can be asked to identify the field or attribute for which they wish to add distinct criteria at block 250. The user can then be prompted to identify the number of distinct values for the specified field or attribute that must be present in the data activity (meeting the other step criteria) for the activity to meet the overall criteria for the step's occurrence at block 255. This value can then be validated at block 260 by checking to ensure that it is less than or equal to the volume of activity specified as being required for the given analysis step, as illustrated in FIG. 8, block 135, and more specifically block 180 as it relates to block 135.

The user can then be asked to identify the number of distinct values for the specified field or attribute that must be present in the data activity (meeting the other step criteria) for the activity to considered as continuing to meet the overall criteria of the step's occurrence (after having already met the active step criteria) at block 265. This value can then be validated at block 270 by checking whether this value is less than or equal to the continued volume of activity specified as being required for the given analysis step, as illustrated in FIG. 8, block 140, and more specifically block 180 as it relates to block 140.

After the creation of any type of criteria item, the user can then be asked to specify whether or not they would like to create additional content criteria at block 225. If the user indicates that the creation of additional content criteria is desired, processing returns to block 195. Processing instead returns to block 147 of FIG. 8 if the user indicates that no more content criteria is to be created.

Computer-Implemented Process for Threat Model Analysis

Referring now to FIG. 10, this figure illustrates an exemplary logic flow diagram of a computer-implemented process for threat model analysis using data collected by the Activity Processor. The logic flow described in FIG. 10 is the top-level processing loop of the Threat model analysis engine and can be seen as repeating while the threat model analysis engine 41 is in operation.

During initialization, at block 280, the threat model definitions, including single step models representing “for corroboration” policy items, are loaded into memory for processing. In addition, common data activity is also retrieved for a determined window of time for each common data type defined in threat model definitions and loaded into memory.

The process can then begin the main analysis cycle processing loop at block 290. The process can continue by retrieving a list of entities configured and scheduled for analysis at block 295. This loop can continue by looping on each scheduled entity for analysis, returning to block 300 for each scheduled entity/company. For each entity, the process can loop for each common data type for which the entity has data. Per each type of common data, threat model analysis is then performed at block 310. If another common data type exists for an entity, it is then processed, completing the described common data type loop (test for additional common data types for the entity is performed at block 315). Then, if another entity has been configured for analysis, (test performed at block 320), it is processed.

Referring now to FIG. 11A, this figure illustrates an exemplary logic flow diagram of the process to serialize a threat model definition. The serialized representation of a threat model definition can comprise the model general information 325, as illustrated in FIG. 11B. It can comprise one to many threat model step definitions, which can be looped on for serialization during storage (block 330 represents the analysis). During threat model step definition storage, the criteria related to each step can be serialized. After the serialization of each criteria item, it can be determined whether more criteria exists at block 340, leading to it also being serialized. After the serialization of each threat model step definition, it can be determined whether or not another step exists at block 345, leading to it also being serialized. After completed serialization of the threat model definition, the related data can be stored in a persistent storage device for high speed access at block 350.

The serialized definitions resulting from this flow are retrieved and interpreted for core logic analysis by the Threat Model Analyzer.

Referring now to FIG. 11B, this figure is a functional illustration of one possible embodiment of general information that can be serialized as part of a threat model definition, as described in FIG. 11A, block 325. This information can include such items as the name, owning company, author, significance, and enablement of the defined threat model.

Referring now to FIG. 11C, this figure is a functional illustration of one possible embodiment of information that can be serialized with each defined threat model step. This information can include a identification of the threat model the step definition belongs to, the ordered number of the step as it exists in the threat model, identification of the common data type for which activity it is defined for, threshold criteria related to its active occurrence, threshold criteria related to its continued occurrence, the persistence type (as described for FIG. 8, block 147), its relationship to the following step when one exists (as described in FIG. 8, block 155), and an indicator as to whether or not source and destination related attribute values should be switched when used in relationship to the following step of the threat model when a following step exists.

Referring now to FIG. 11D, this figure is a functional illustration of one possible embodiment of information describing the specified content criteria for a given step of a threat model definition. This information can be serialized with each step as illustrated in FIG. 11, block 335. Each content criteria item can include identification of the threat model and step it belongs to, identification of the type of criteria it describes (as illustrated in FIG. 9, block 195), and identification of the common data field or attribute. It can also comprise other items depending on the type of criteria it represents. For criteria of distinct type, the number of distinct values for activation and continuance can be stored. For attribute and common data the positive/negative match indicator, field operator, and value can also be specified.

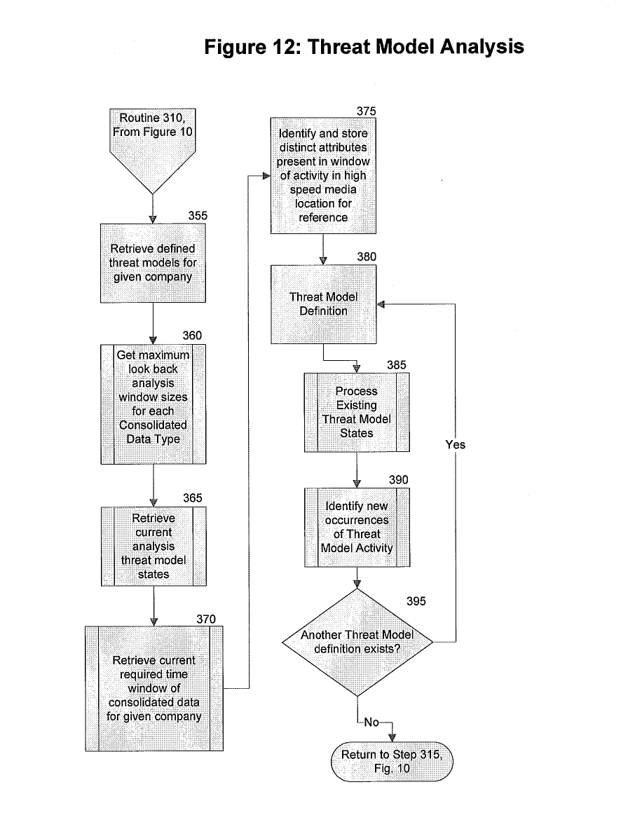

Referring now to FIG. 12, this figure is a logic flow diagram illustrating a sub process of threat model analysis performed by the Threat Model Analysis Engine 41. More specifically, it is a sub process of FIG. 10, block 310, performed for any one entity on a specific common data type of data. The process of consolidated threat model analysis can begin with the retrieval of threat model definitions assigned by user configuration to the provided entity and retrieval of common data type for analysis at block 355. The process can then perform a sub process to determine the window of time for which data activity is to be analyzed for performing the present threat model analysis at block 360. The process can then retrieve all states, stored in persistent storage, that are related to the current entity and threat models at block 365. The process can then perform a process to retrieve all collected and translated common data activity for analysis at block 370. The process can then perform general statistic analysis and indexing of distinct attributes present in the retrieved data activity window. These items can be stored in high speed memory for later reference at block 375. The process can then loop on each retrieved threat model to perform data threat model analysis (loop begins at block 380). Per each threat model definition, the process can perform a sub process of data activity analysis on the active states related to the current threat model at block 385. The process can then perform a process to identify new occurrences of the current threat model being analyzed at block 390. Activity of each threat model definition for which a state already exists is processed first at block 385. This is done to ensure the most up to date boundaries of existing already identified threat model activity is identified in time before the process of identifying entirely new occurrences of any given threat model begins at block 390. This can help to ensure distinctness in occurrence. After analysis of each threat model, the process can check whether or not another exists at block 395. The existence of another threat model leads to further analysis and completion of the loop per for each threat model definition. Processing returns to the main analysis engine process loop if complete, as illustrated in FIG. 10, block 315.

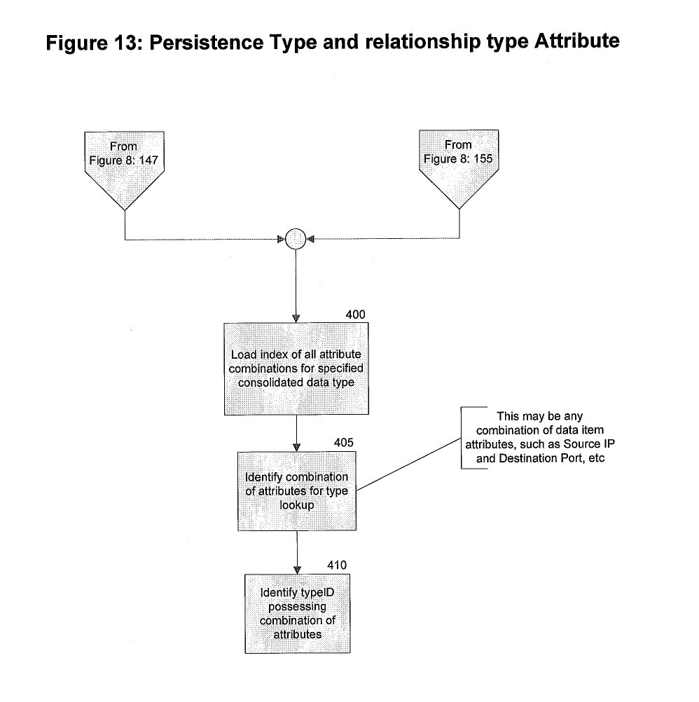

Referring now to FIG. 13, this figure is a logic flow diagram illustrating a shared sub process of threat model definition for the identification of persistence type, as illustrated in FIG. 8, block 147, and the identification of relationship type, as illustrated in FIG. 8, block 155. This process can begin by loading an index of all combinations of attributes present in the specified threat model step's common type of data at block 400. The user can then be asked to identify the combination of attributes he or she wishes to use to identify the persistence or relationship type at block 405. The process can then look up the unique identifier present in the index related to the chosen combination of attributes and return this value to the calling process for use in threat model definition at block 410.

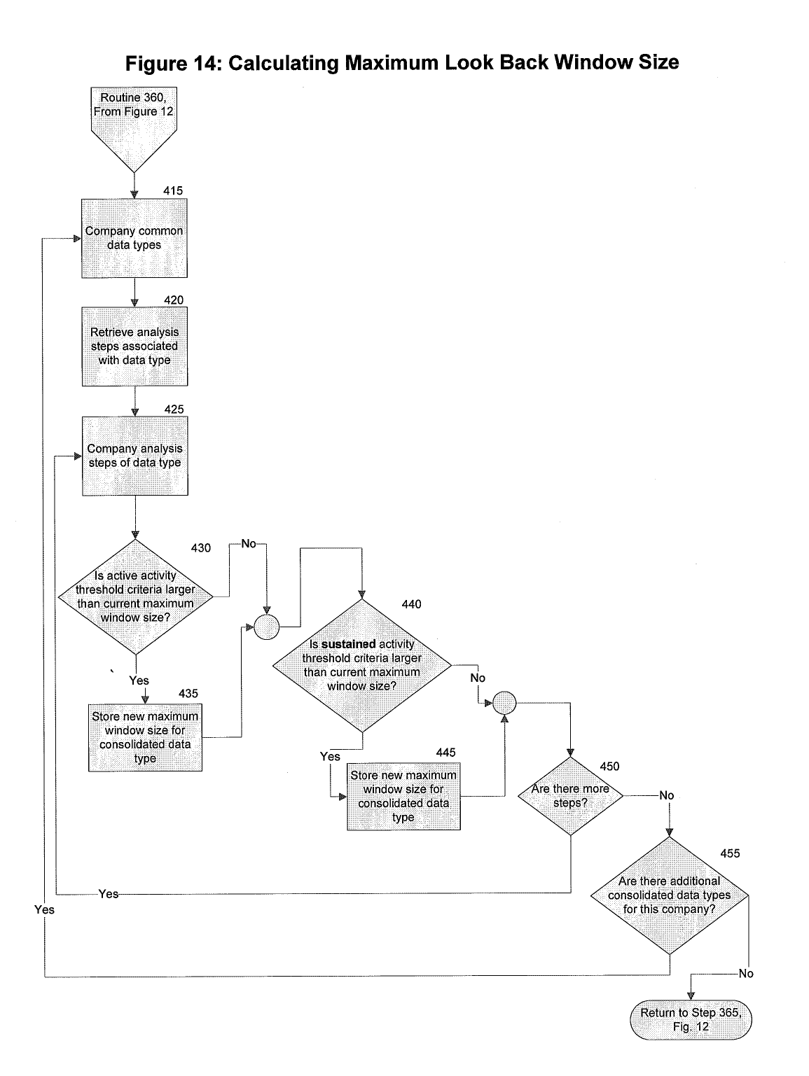

Referring now to FIG. 14, this figure is a logic flow diagram illustrating the determination of the maximum look back window size for analysis of common activity data for a provided set of threat models. More specifically, this is a sub process of the threat model analysis process as illustrated in FIG. 12, block 360. This process can begin by identifying and looping on the distinct common data types associated with the steps defined in the provided set of threat model definitions at block 415. Per each common data type, the process can continue by retrieving the time related criteria, comprising active and continuance time criteria (as illustrated in FIG. 8, blocks 135 and 140) associated with threat model steps in the provided threat model definitions at block 420. The process can then loop per each identified threat model step of time criteria (the loop beginning at block 425). Per each step criterion, the process can determine whether the amount of time specified in criteria for activation is larger than the maximum time placeholder value (which starts at 0 when the process begins) at block 430. If larger, the current maximum time placeholder value is updated to the larger activation time criteria, at block 435. The process can then determine whether the amount of time specified in criteria for continuance is larger than the current maximum time placeholder value for continuance criteria at block 440. If the specified amount is larger, the placeholder of the current maximum time for continuance criteria is updated to the larger continuance time criteria at block 445. After these comparisons, the process can proceed to check whether or not another criteria step in the provided threat model definition set exists, and, if so, continues to process the next one. In this manner, the system can complete the loop of processing each step of criteria in the threat model definition set provided (the check being performed at block 455).

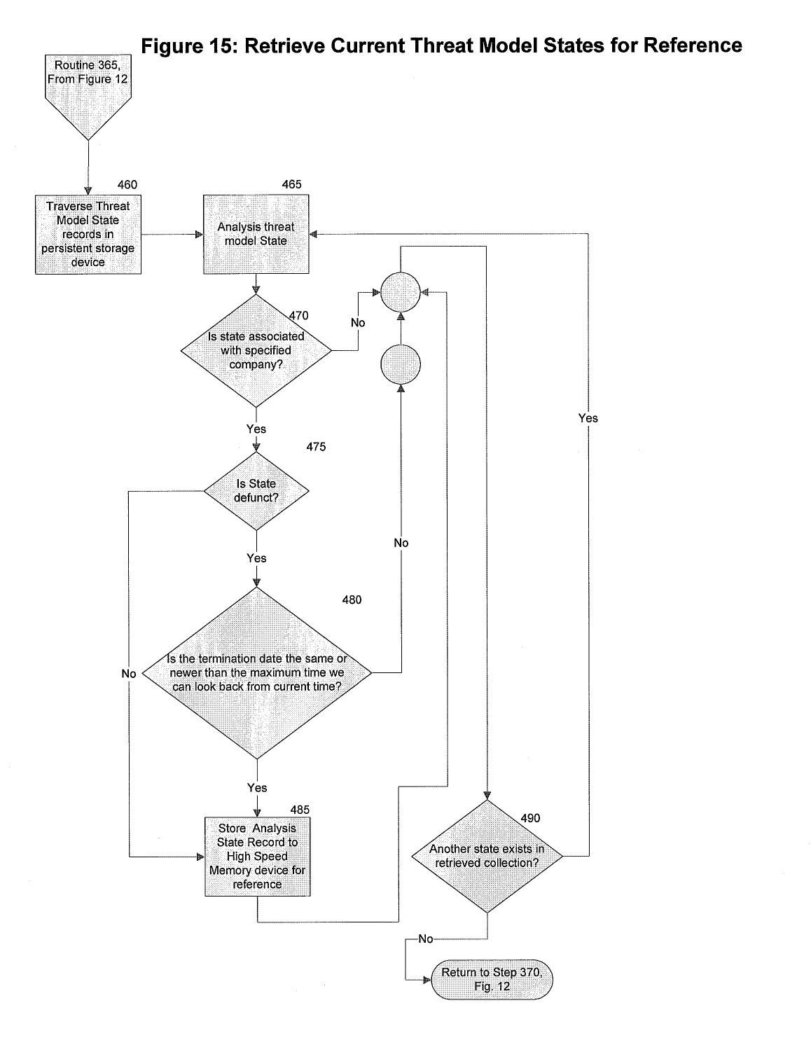

Referring now to FIG. 15, this figure is a logic flow diagram illustrating the determination and retrieval of threat model states from persistent storage for analysis processing by the analysis engine. More specifically, this is a sub process of the threat model analysis process as illustrated in FIG. 12, block 365.

The process described in FIG. 15 can begin by traversing the persistent records representing each serialized state at block 460. The process can then loop on each identified analysis state (the loop starting at block 465). For each state, the process can determine if the activity described by the state is associated with the provided entity for analysis at block 470. If the state is determined to not belong to the provided entity, the process can move on to determining if another state exists for traversal at block 490. If the state is determined to belong to the provided entity, the process can then determine whether or not the state's activity indicator specifies that the state is defunct. More specifically, a defunct activity indicator indicates that the activity the state describes did not occur or did not continue to occur in the appropriate time window specified in criteria (the check of the activity indicator being performed at block 475). If the state is determined to not be defunct, it is added to a high speed memory device for processing by the analysis engine at block 485. If the state is determined to be defunct, its time of termination is checked to determine whether or not it became defunct within the maximum window of activity time currently being analyzed at block 480, as determined earlier in the analysis process and illustrated in FIG. 14. If the state, although defunct, is determined to have become defunct within the current data activity window of time, the state is still added to the high speed memory device for use in analysis at block 485. This is done to prevent new occurrences of its activity that relate to activity already associated with the state. Whether the state is added to the high speed memory device list or not, the process then examines whether or not another state exists for traversal and loops to process it if one exists at block 490.

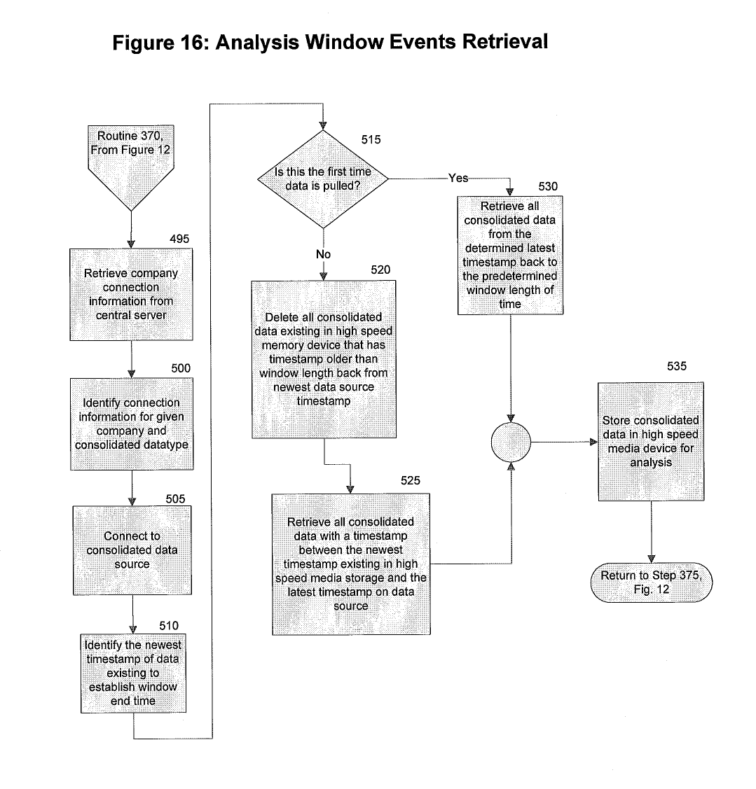

Referring now to FIG. 16, this figure illustrates the retrieval of translated/common activity data of a specific common data type and belonging to a specific entity for analysis. This process can begin with retrieval of connection information stored in configuration indexes in persistent storage at block 495. The process can then identify where the data of the provided common data type and entity is located and how to connect to it at block 500. The process can then connect to the device where it is determined that the data can be found at block 505. The process can then determine the latest time of activity for the given entity and common data type at block 510. This can be determined by examining the most recent timestamp attribute stored in the given entity's common data type data. The time value determined from this process can also be stored in the high speed memory device for utilization in analysis as the end point of the analysis common data time window. The process can then determine if this is the first time it is retrieving common data activity for the given entity and common data type at block 515. If this is the first time, the process can then retrieve all data stored in the persist storage it has connected to that has timestamps corresponding to the latest timestamp and the determined look back window at block 530. If it is determined that common data activity for this entity has already been stored in high speed memory, the process can continue to remove all common data items stored on the high speed memory device that have a timestamp earlier than the common data activity window start, determined by subtracting the provided maximum window size from the determined latest activity time at block 520. The process can then retrieve all common data activity items from the persistent storage device it is connected to that have a time stamp attribute between the newest timestamped items currently found on the high speed memory device for the given entity and common data type and the determined latest activity time on the persistent data storage at block 525. After retrieving the required common data activity items from persistent storage, the process can store these items in on the high speed memory device to make them available for analysis at block 535.

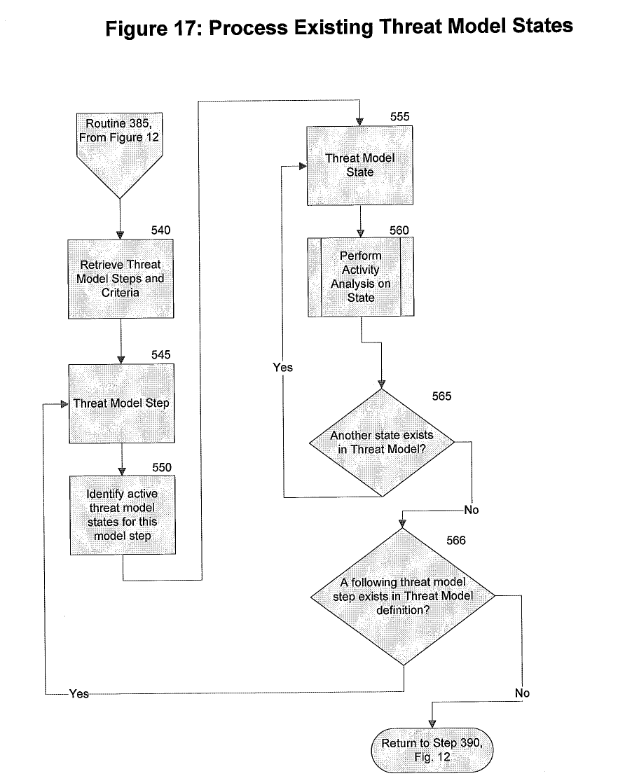

Referring now to FIG. 17, this figure is a logic flow diagram illustrating the general process for analysis of active threat model points that have already been identified and are represented by states on the high speed memory device. This process can begin by retrieving the provided threat model's definition, including steps and related criteria, from the high speed memory device for processing at block 540. The process can then loop on each step of the threat model in the order the steps are defined in the model (the loop beginning at block 545). This is done to allow for any following step states that are created during the processing of a step to be processed immediately afterwards and not be missed in the analysis cycle. For each step of the provided threat model, the process can then identify the states on the high speed memory device that are marked as being active and representing the current threat model and step at block 550. The process can then loop on each of these states for analysis at block 555. Per each state, the process can then perform the sub process of activity analysis for the given state and current common data window of activity at block 560. After processing each state, the process can determine whether or not another state exists for the given threat model and step and continue processing at block 565. If another state for the given step does not exist, the process can determine if a following step exists in the provided threat model definition and continue on to process states for that step to complete the loop on each step of the provided threat model at block 566.

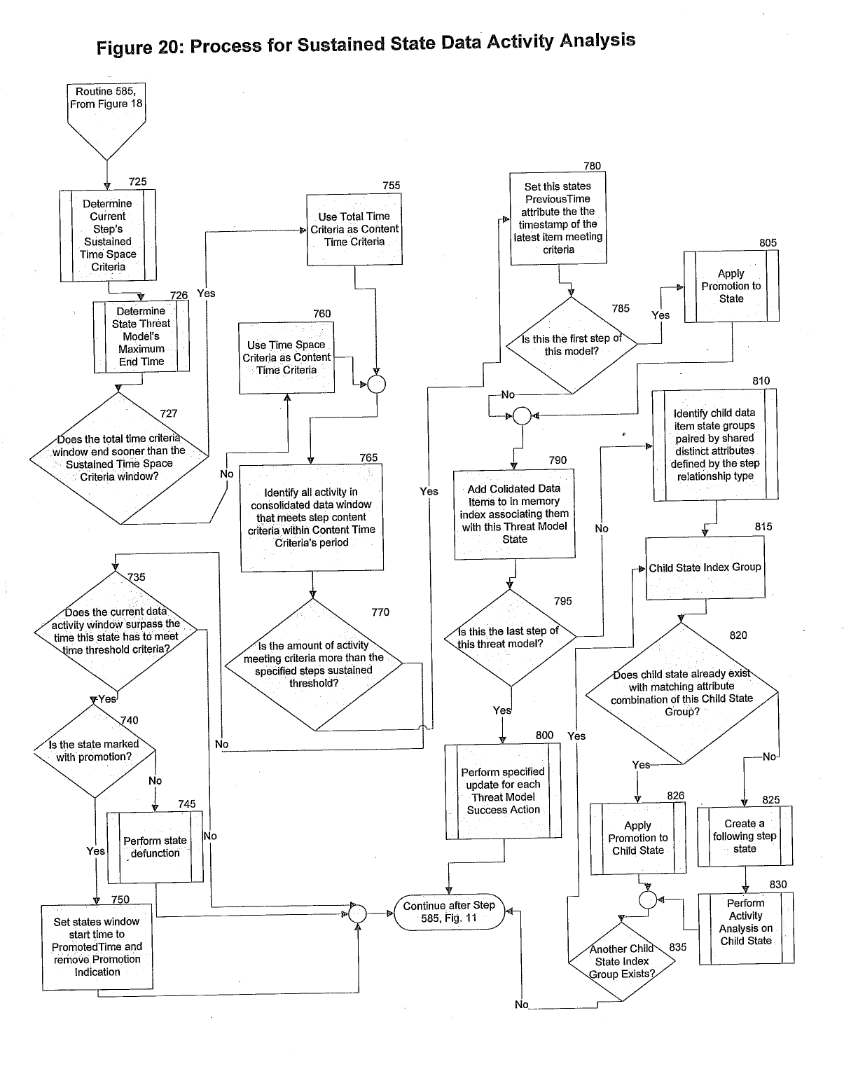

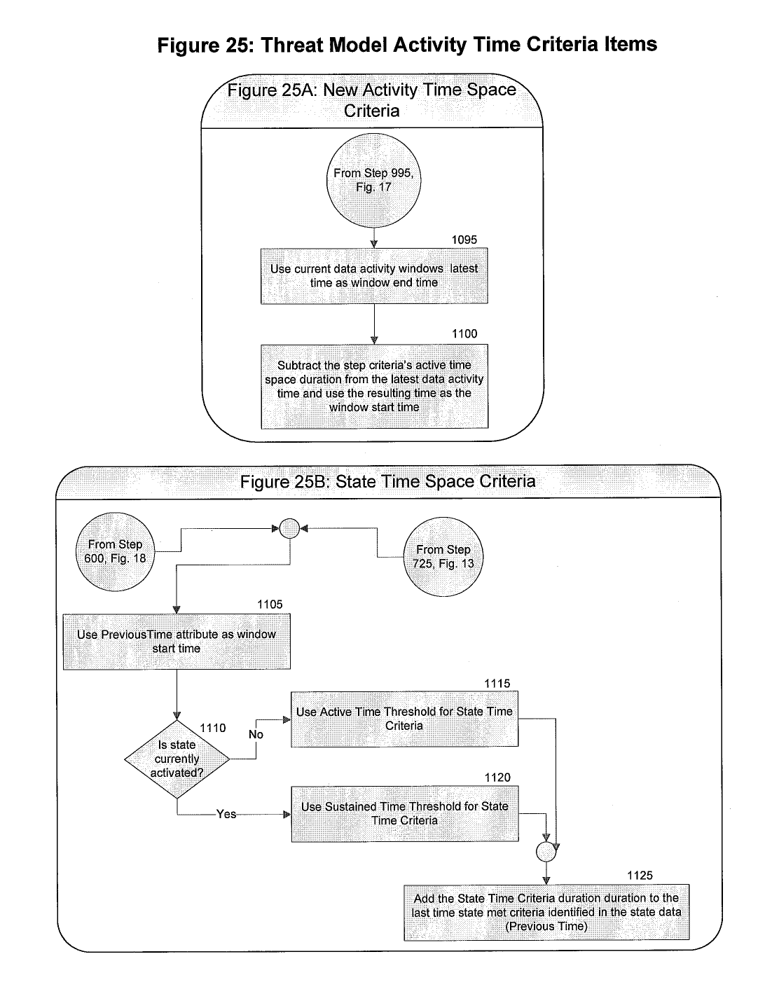

Referring now to FIG. 18, this figure is a detailed logic flow diagram illustrating the sub process of common data activity analysis for a provided threat model point, represented by a state associated with a specific threat model and step provided. This process can begin by performing a sub process to interpret the criteria associated with the given step of the provided threat model and building the appropriate items for application of the criteria to the common data activity window at block 570. The process can then perform a sub process to determine the maximum end time for which to search common data activity for the activity the state represents at block 575. The process can then determine whether or not the activity represented by the provided state is marked as activated or not at block 580. This marking represents whether or not the activity for this step in the threat model is being actively sought or has already occurred and is being monitored for continuance. If the state activity has been determined as having already occurred and requires monitoring for continuance, the process can continue to perform the sub process of Sustained State Threat Model Analysis at block 585, as illustrated in FIG. 20. If the state is determined to be active, the process can continue to perform a sub process to determine the time window requirements within which activity meeting the step's criteria must be found based on the step's time criteria at block 600, as configured in threat model definition and illustrated in FIG. 25B. The process can then determine whether the total time specified in the threat model definition for the threat model to be allowed to exist ends sooner than the determined time in which this state must meet its own criteria at block 605. If the time during which data activity meeting the criteria must be found (based on the threat model's total time criteria) is sooner than the step's criteria, the total time is used in calculating the overall window of time common data activity meeting the criteria is searched at block 625. If the time during which data activity meeting the criteria must be found (based on the threat model's total time criteria) is later than the step's criteria, the step's own time criteria is used in calculating the overall window of time common data activity meeting criteria is searched at block 610. The process can then use the threat model step's content criteria in addition to the determined time window criteria to identify all common data activity present in the common data activity window on the high speed memory device that meets criteria at block 615. The process can then determine whether or not the volume of common data activity items found to meet the time and content criteria is greater than or equal to the volume specified for Activation activity threshold criteria in the threat model step definition at block 620, as illustrated in FIG. 11C.

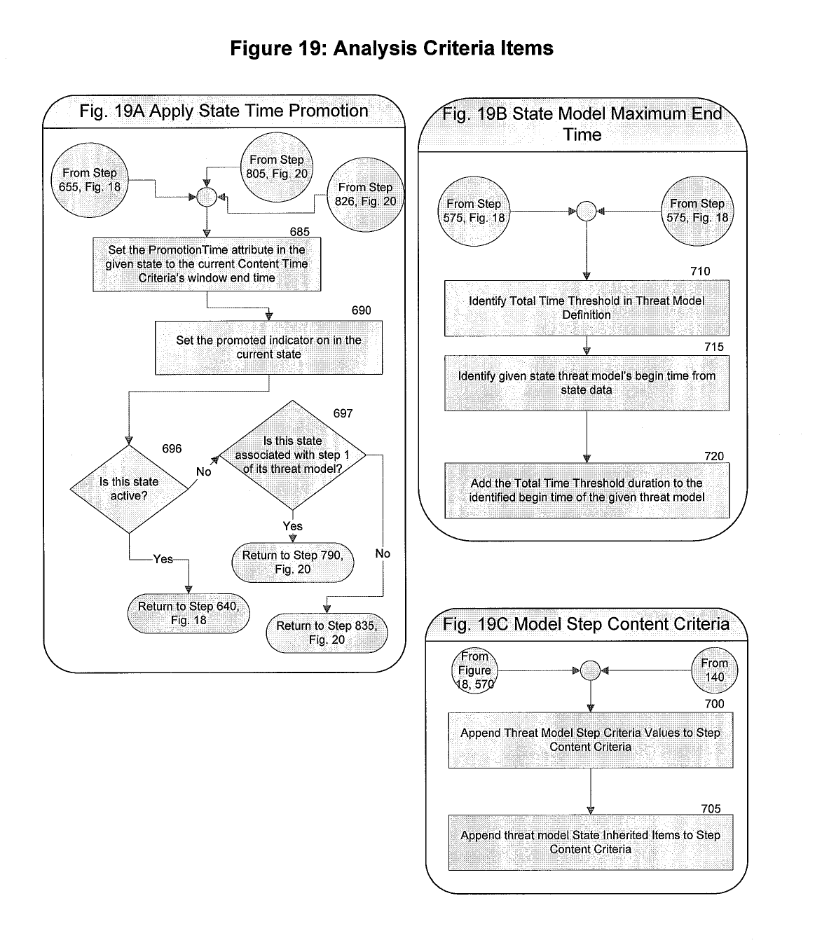

If the volume of activity items meeting the criteria meets or exceeds related activation activity threshold criteria, the process can then mark the state being processed as having met its criteria and no longer being the step in the given threat model that is currently being sought without having met criteria at block 630. The process can then update the provided state's previous time attribute, which represents the beginning time which data activity meeting criteria is sought for the next analysis cycle at block 635. The process can then determine whether or not this is the first step of the provided threat model at block 640. If it is the first step of the threat model, the process can then perform a sub process, promoting the provided state at block 655, as illustrated in FIG. 19A. Whether or not the current step is the first step in the threat model, the process can then add an identifier used to uniquely identify each common data item found to meet criteria to the high speed memory device. Each common data item so identified can be associated with the provided state, including its threat model, step, and the state's specific occurrence group identifier at block 640. The process can then determine whether or not a following threat model step exists in the provided state's threat model definition, 645.

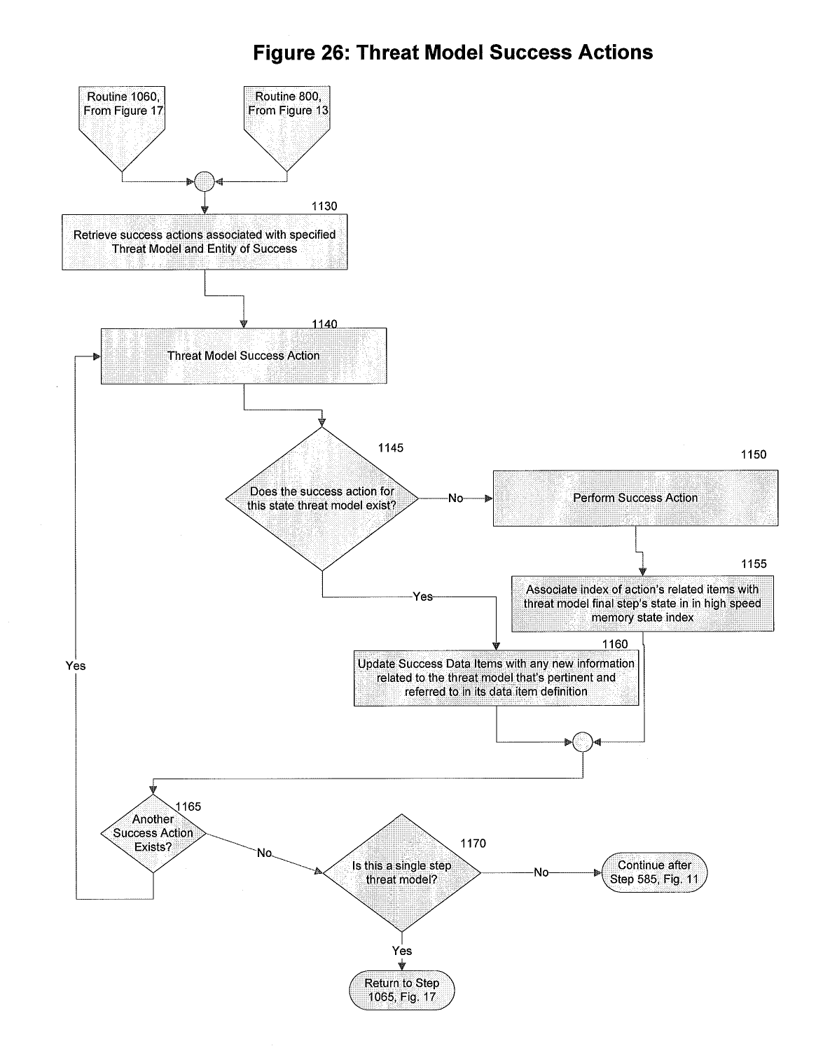

If a following step in the threat model does not exist (meaning this is the provided state's last step in its associated threat model definition), a sub process can perform each of the threat model's associated success actions at block 650, as illustrated in FIG. 26. If a following step exists in the provided state's threat model, a sub process can be performed to identify each of the following step states, referred to as child states. These child states can be created for continued analysis in the threat model of the following threat model step at block 660. The process can then loop on the child state index, at block 665 (the index being provided from the sub process of block 660). Per each child state identified, the process can then perform a sub process to create a child state associated with the following step of the provided state's threat model and also associated with the provided state's occurrence state group at block 670. The process can then perform the sub process for performing data activity analysis for the newly created child state at block 675. The process can then identify whether or not another child state exists for creation in the child state index and perform the same creation and analysis procedure for each one, completing the loop on each child state identified in the index at block 680.

If the volume of activity items meeting content and time criteria is determined not to meet related activation activity threshold criteria at block 620, the process can then determine whether or not the current data activity window on the high speed memory device ends after the determined point in time the provided state has to meet its criteria at block 590. If the current data activity window ends in time before the determined time in which the provided state must meet criteria, the process returns to the calling process without performing any action on the provided state. If the current data activity window ends in time after the determined time the state must meet criteria, the process would then determine whether or not the state is marked as having a promotion at block 595. If the state's promotion indicator is set, the process can then utilize its promotion by setting the state's criteria data window start time to the time specified in the promotion and remove the promotion indicator at block 597. If the state is determined to not have an available promotion, a sub process is performed to defunct the state at block 598.

Referring now to FIG. 19A, this figure is a logic flow diagram illustrating the application of a promotion to a given state. State promotions are utilized to increase the amount of time during which threat model activity is monitored as a result of the occurrence of a previous step in the model or the state being the first step of the threat model. This process can begin by setting the promotion time attribute of the provided state to the latest common data activity time that occurred causing the promotion at block 685. The process can then set the promotion indicator on the provided state at block 690. The promotion indicator is used to identify that the state has a promotion available upon failure to meet criteria. The process can then determine whether or not the state is active at block 696, meaning the activity its criteria describes is being actively sought in analysis instead of having already been seen and being monitored for continuance. If the state is active, the calling process is determined to be the State Activity Analysis procedure and the calling process is returned to. If the state is not active, the process for sustained state processing is returned to based on whether the state is associated with the first step of its associated threat model or not at block 697.

Referring now to FIG. 19B, this figure is a logic flow diagram illustrating the determination of a given threat model's maximum time within which all its points must end activity analysis. This is referred to as the total time criteria. This process begins by identifying the threat model's configured total time threshold provided in the threat model definition as configured by the user at block 710, illustrated in FIG. 8, at block 165. The process can then identify the beginning timestamp stored in high speed memory along with the associated threat model upon occurrence of the first step at block 715. The process can then perform addition of the identified amount of time for the total time threshold and the beginning time of the provided state's threat model at block 720 to determine the time at which the provided threat model must end.

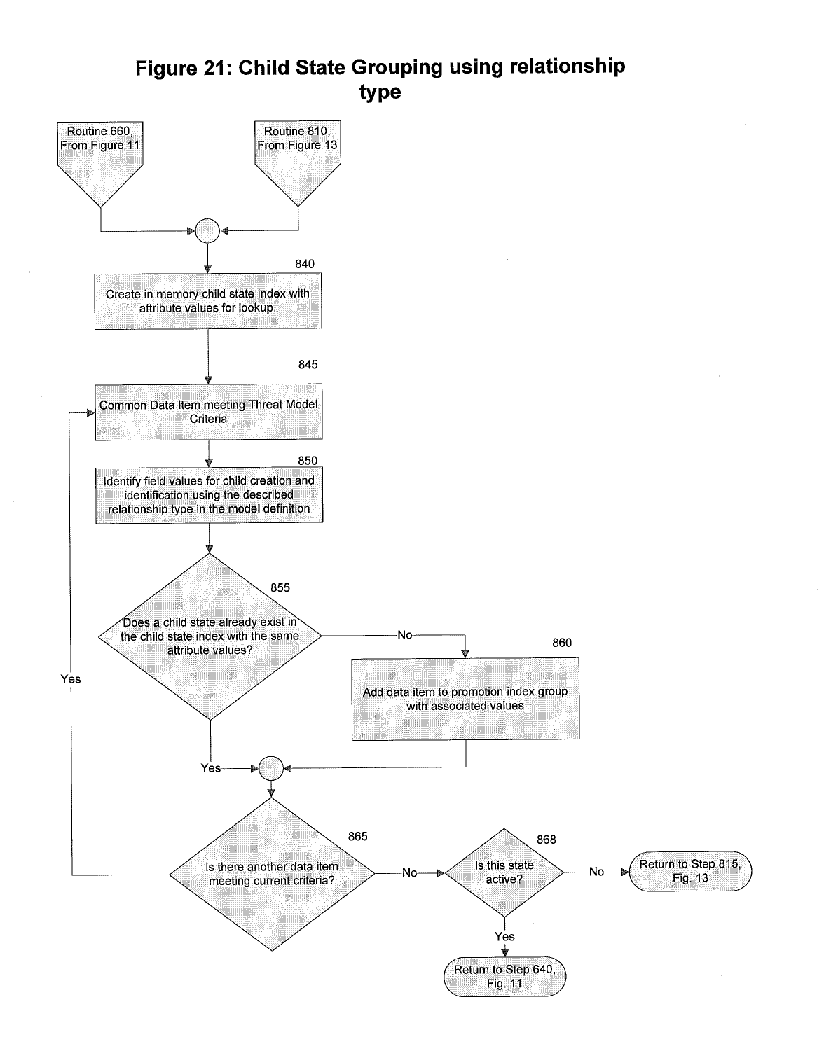

Referring now to FIG. 19C, this figure is a logic flow diagram illustrating the formulation of overall criteria. This overall criteria is used with determined time criteria by the analysis process to identify appropriate common data activity items that meet criteria for a given threat model step and occurrence. This process can begin with the interpretation and addition of all content related criteria items at block 700. These items can be configured during definition by the user in the provided threat model definition's step, as illustrated in FIG. 9. The process can then append any criteria attribute values that have been inherited from a previous step in the provided state's associated threat model at block 705. This inheritance can be based on relationship type and determination by a sub process during creation, as illustrated in FIG. 21.

Referring now to FIG. 20, this figure is a logic flow diagram illustrating the process of data activity analysis for states that have met their activation criteria and require analysis to determine the continuance of their described activity. This process can begin by performing a sub process to determine the common data activity time window, based on the state's associated threat model step criteria, during which the activity described by criteria must occur to meet criteria at block 725, as illustrated in FIG. 25B. The process can perform a sub process to determine the maximum time during which the entire given state threat model can occur based on total time criteria at block 726, as illustrated in FIG. 19B. The process can then determine whether the time the activity meeting criteria must occur in, is shorter using the total threat model criteria or the state's associated step criteria at block 727. If the total time is shorter, the total time criterion is chosen for use in the state activity criteria at block 755. If the time required for data activity criteria is shorter based on step criteria, the determined step time criterion is used at block 760. The process can then utilize determined criteria to identify all common data items in the common data activity window on the high speed memory device that meet content and time criteria at block 765. The process can then determine whether or not the volume of common data activity items found to meet time and content criteria is greater than or equal to the volume specified according to continuation activity threshold criteria in the threat model step definition at block 770, as illustrated in FIG. 11C.

If the volume of activity items meeting criteria meets or exceeds related continuation activity threshold criteria, the process can then update the provided state's previous time attribute at block 780. The previous time attribute represents the beginning time which data activity meeting criteria is sought for the next analysis cycle. The process can then determine whether or not this is the first step of the provided threat model at block 785. If it is the first step of the threat model, the process can then perform a sub process, promoting the provided state at block 805, as illustrated in FIG. 19A. Regardless of whether the current step is the first step in the threat model, the process can then add the identifier used to uniquely identify each common data item found to meet criteria at block 790. This identifier can be stored in the high speed memory device and be used to associate each common data item with the provided state, including its threat model, step, and the state's specific occurrence group identifier. The process can then determine whether or not a following threat model step exists in the provided state's threat model definition at block 795.

If a following step in the threat model does not exist (meaning that the current state represents the last step in its associated threat model definition) a sub process can be utilized to signal updates to all related success action items at block 800, as illustrated in FIG. 26. If a following step exists in the provided state's threat model, a sub process is performed to identify each of the following step states, referred to as child states. The child states can be created for continued analysis in the threat model of the following threat model step at block 810. The process can then loop on the child state index at block 815 (provided from the sub process of block 810). Per each identified child state, the process can then determine whether or not a child state exists in the high speed memory index of threat model states that has matching threat model, step, state occurrence group identifier, and relationship attributes at block 820. If a matching child state already exists in the high speed memory index, the process can apply a promotion to the identified child state at block 826, as illustrated in FIG. 19A. If a matching child state does not exist for the child state in the child state index, the process can then perform a sub process to create a child state associated with the following step of the current state's threat model and also associated with the provided state's occurrence state group at block 825. The process can then perform the sub process for performing data activity analysis for the newly created child state at block 830. The process can then identify whether or not another child state exists for creation in the child state index and perform the same creation and analysis procedure for each, completing the loop on each child state identified in the index at block 835.

If the volume of activity items meeting content and time criteria is determined not to meet related continuation activity threshold criteria (returning to block 770) the process can then determine whether or not the current data activity window on the high speed memory device ends after the determined point in time that the current state has to meet its criteria at block 735. If the current data activity window ends in time before the determined time in which the state must meet criteria, the process returns to the calling process without performing any action on the provided state. If the current data activity window ends in time after the determined time the state must meet criteria, the process can then determine whether or not the state is marked as having a promotion at block 740. If the state's promotion indicator is set, the process can then utilize its promotion by setting the state's criteria data window start time to the time specified in the promotion. The promotion indicator can be removed at block 750, the promotion indicator having been used. If the state is determined to not have an available promotion, a sub process is performed to defunct the state at block 745.

Referring now to FIG. 21, this figure is a logic flow diagram illustrating a sub process of analysis which is used upon the successful occurrence of activity described in a threat model step. This process is used to determine the distinct potential points that exist in the following step of the provided threat model based on the described relationship between the current step that has met criteria, the following step, and the current step's identified common data activity. This process can begin by creating a blank index to hold determined potential threat points later in this process at block 840. Each of the items that can be added to the index can include a unique identifier, along with the appropriate common data attribute values that make it unique from other potential threat model points in the same step. The process can then loop on each of the common data activity items that have been found and used in analysis for the current step to meet criteria at block 845. Per each common data activity item, the process can then identify the common data attribute values present in the common data item which are described by the relation type in the threat model definition for the step meeting criteria.and used to determine the distinct points in the threat model that can exist for the following step of analysis at block 850. The process can then determine whether or not a child state with the same attribute value(s) has already been added to the child state index at block 855. If a child state has not already been added to the index, representing a distinct threat model point of the next step, a child state is added with unique identifier and common data values at block 860. The process can then determine whether or not another common data item that meets criteria exists and continue processing each of them, completing the loop for each common data item at block 865. The process can then determine whether or not the provided state to the sub process has met activation already at block 868, and return to the appropriate sub process.

Referring now to FIG. 22A, this figure is a logic flow diagram illustrating the sub process of creating a new state (representing a threat model point) for the first step of a threat model. The created state will be both maintained on the high speed memory device of the present invention during processing and serialized for later reference in presentation and analysis to a persistent storage device. This process can begin by creating a blank state record on the high speed memory device at block 870. The process can then generate a new unique identifier for the state's associated threat model and unique occurrence, storing this value in the state's new record at block 875. The process can then identify the attributes described by the relationship type in its associated threat model definition between its previous step and the step the new state is being created for at block 880. The process can then set the value in matching state relationship fields for these attributes in the state's record for later distinct identification and reference in analysis to its described threat model point at block 885. The process can then set the previous time attribute value in the new state's record to the latest time stamp provided in identified common data activity that met criteria of the previous step at block 890 (effectively causing the new child state's described activity to be searched for in common data at the earliest data activity timestamp found in the previous threat model step's common data activity meeting criteria). The process can then also set the begin time attribute in the newly created state to the earliest common data activity item time of the previous step's identified activity at block 895. This is done for reference and determination of total time criteria for the described threat model occurrence. The process can then set the newly created child state's promotion indicator to not being promoted at block 900. The process can then set the newly created state's step activation indicator, at block 905, so as to identify this state branch as having already met activation criteria through its step in the threat model and now will be processed for continuance. This is done for states created for the first step of any threat model because a state is not created for the first step of any threat model until the activity it describes by its criteria has been found in analysis.

Referring now to FIG. 22B, this figure is a logic flow diagram illustrating the sub process of creating a state for the following step of a threat model, describing a specific following point in the threat model. More specifically, this logic is used for the creation of points in an occurring threat model that follow a point that has met its activation or continuance criteria and for which no point yet exists. This process can begin by creating a blank state record on the high speed memory device at block 910. The process can then set the newly created state's threat model occurrence group identifier to the one possessed by its parent state at block 915. The process can then identify the attributes described by the relationship type in its associated threat model definition between its previous step and the step for which the new state is being created at block 920. The process can then set the value in matching state relationship fields for these attributes in the state's record for later distinct identification and reference in analysis to its described threat model point at block 925. The process can then copy any relationship attribute values from the parent state associated with the newly created child state into the child state's matching record attributes at block 930. These values are used in addition to other criteria in child state analysis—assimilating inheritance from one point in the threat model to any child states created from that point on. The process can then set the previous time attribute value in the new state's record to the latest time stamp provided in identified common data activity that met criteria of the previous step at block 935 (effectively causing the new child state's described activity to be searched for in common data at the earliest data activity timestamp found in the previous threat model step's common data activity meeting criteria). The process can then set the begin time attribute to the same value possessed by its parent state at block 940. The process can then set the newly created child state's promotion indicator to not being promoted at block 945. The process can then set the active step indicator in the newly created state to active at bock 946. This causes the state's described activity to be sought using criteria required for activation in the threat model definition for the given step. This is indicative in presentation of the threat model that this threat model point has not met activity criteria for occurrence.

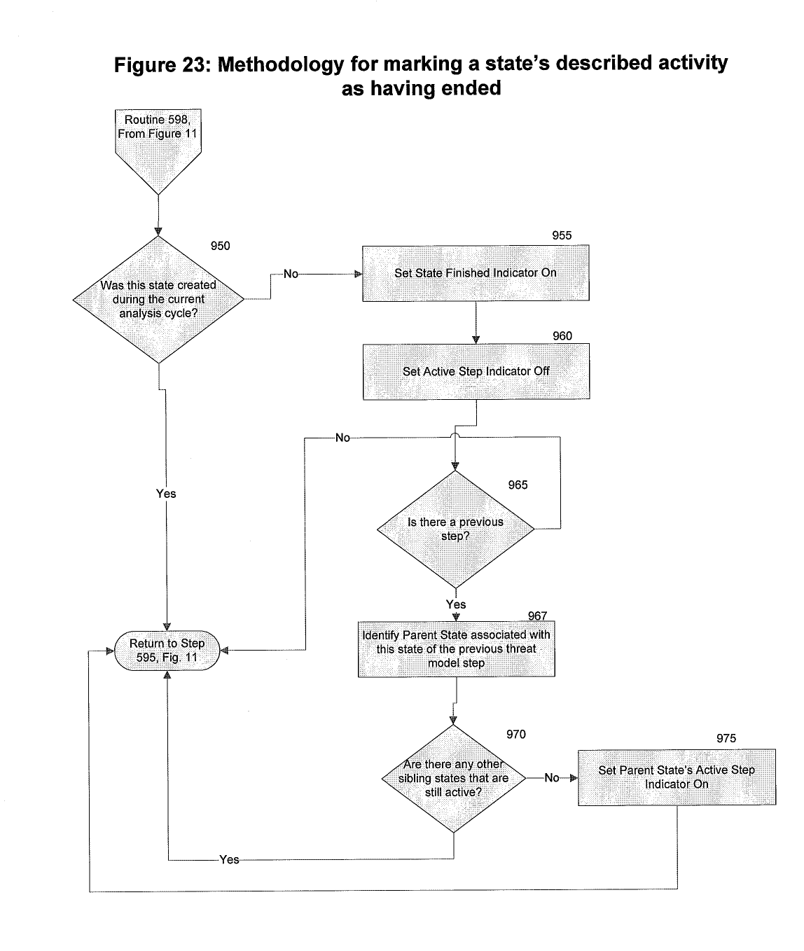

Referring now to FIG. 23, this figure is a logic flow diagram illustrating the process in which a state, describing a threat model point, is made defunct. This indicates that its described activity has failed to either meet activation criteria or failed to demonstrate continuance by meeting continuation criteria. This process can begin by determining whether or not the provided state that has failed criteria was created during the current analysis process loop, referred to as analysis cycle at block 950. If the state was created during the current analysis cycle, it is left alone and the overall sub process is not performed. This is to allow at least one update to be made to the common data activity window before failure is trusted. This is due to some source devices being potentially late in reporting based on differing technologies. If the provided state was not created in this analysis cycle, the process can then mark its finished indicator at block 955, which is used to indicate whether or not a state has completed analysis of its described activity. The process can then set the state's Active Step indicator to off to indicate that this point in the associated branch of the occurring threat model is no longer active at block 960. The process can then determine whether or not a previous step in its associated threat model exists at block 965. If a previous step exists, the process can then identify the parent state of the current state in the threat model at block 967. Using the identified parent state, the process can then determine whether or not any other child states of the identified parent state exist with an Active Step indication setting at block 970. This determines whether or not sibling points in this instance of the associated threat model are still active for analysis (whether any of them are still being analyzed for activation criteria or continuance). If no sibling child states exist that are associated with the provided state's parent, the process can then set its parent state's active step indicator, identifying that the previous point in its associated threat model is now the last point in the threat model branch that remains active for analysis at block 975.

Referring now to FIG. 24, this figure is a logic flow diagram illustrating the process in which new occurrences of any threat model are identified by the analysis process in common data activity. This process can begin with the retrieval of the provided threat model's steps and associated criteria into high speed memory for reference throughout the process at block 980. The process can then loop on each step of the provided threat model to perform analysis at block 985. Per each step of the provided the model, the process can then build associated content criteria for the given step by interpreting each of the content criteria items associated with the step in the threat model definition. These can then be translated to processor compatible logic for identifying common data activity that meets criteria at block 990.

This process can begin by performing a sub process to determine the common data activity time window criteria (based on the state's associated threat model step criteria) during which the activity described by criteria must occur to meet the criteria, at block 995, as illustrated in FIG. 25B. The process can then identify all common data items in the common data activity window on the high speed memory device that meet content and time criteria at block 1000. The process can then loop on each common data item that has been found to meet general content criteria in the common data activity window at block 1005. Per each common data item found, the process can then identify the persistence type values it has, by using the data items values for configured persistence type attributes, as illustrated during threat model definition in FIG. 8, block 147. The process can then determine whether or not it has already performed analysis for this threat model for the identified persistence values of the data item at block 1015, continuing on in the loop on each common data item without performing any processing that has already been performed. If analysis of the data item's described activity, based on persistence field values has not been performed, the process can then determine whether or not any active state exists on the high speed memory device that has the same associated threat model, threat model step, and persistence attribute values at block 1020. If an active state already exists for this threat model, step, and persistence values, the process can then continue on to loop on each discovered data item meeting content criteria at block 1005. If no active state exists, the process can then determine whether or not any defunct/finished state exists on the high speed memory device that shares the same threat model, step, and persistence attribute values, and also became defunct after the time of this common data items occurrence, based on its timestamp at block 1025. This determination can help to ensure that no common data item is reused for the same specific threat model step after already being associated with a different occurrence. If it is determined that a related defunct state exists and ended after this data item's occurrence, the process can then continue on to loop on each discovered data item meeting content criteria at block 1005. If no matching defunct state is identified, the process can then utilize determined criteria to identify all common data items in the common data activity window on the high speed memory device that meet content and time criteria, as well as share this data item's identified persistence values at block 1030. The process can then determine whether or not the volume of common data activity items found to meet time and content criteria is greater than or equal to the volume specified by activation threshold criteria in the threat model step definition at block 1035, as illustrated in FIG. 11C. If distinct criteria is also associated with the provided threat model step criteria, the number of distinct values for the specified field in criteria can also be checked for. If the volume of activity specified by criteria or the number of distinct values that can also be specified in criteria for one or more common data fields is not determined to exist, the process can then continue on to loop on each discovered data item meeting content criteria at block 1005.

If the volume and/or distinct values of activity items meeting criteria meets or exceeds related activation threshold and distinct criteria, the process can then create a new Threat Model Occurrence Group with a unique identifier that all states (representing points in this specific occurrence of the threat model) can be associated with at block 1040. The process can then perform a sub process to create a state to represent the first point in the discovered threat model occurrence at block 1045, as illustrated in FIG. 22A. The process can then add the identifier (used to uniquely identify each common data item found and used to meet criteria) to the high speed memory device, associating common data item one with the provided state, including its threat model, step, and the state's specific occurrence group identifier at block 1050, for later reference in analysis and presentation. The process can then determine whether or not a following threat model step exists in the provided state's threat model definition at block 1055. If a following step in the threat model does not exist (meaning that the provided state represents the last step in its associated threat model definition) a sub process can perform each of the threat model's associated success actions at block 1060, as illustrated in FIG. 26. If a following step exists in the provided state's threat model, a sub process is performed to identify each of the following step states, referred to as child states, which can be created for continued analysis in the threat model of the following threat model step at block 1070. The process can then loop on the child state index at block 1075 (the child state index being provided from the sub process of block 1070). Per each child state identified, the process can then perform a sub process to create a child state at block 1080, associated with the following step of the provided state's threat model and also associated with the provided state's occurrence state group. The process can then perform the sub process for performing data activity analysis for the newly created child state at block 1085. The process can then identify whether or not another child state exists for creation in the child state index and perform the same creation and analysis procedure for each one, completing the loop on each child state identified in the index at block 1090. The process can then identify whether or not another common data item exists in the identified data meeting content criteria and perform the same procedure for each one, completing the loop on each common data item meeting content criteria within the data activity window at block 1065.

Referring now to FIG. 25A, this figure is a logic flow diagram illustrating the process of determining the time criteria, represented by the start and end point in time within the data activity window during which activity meeting step criteria must be found for occurrence. This process can begin by identifying the most recent time recorded for a given common data activity item in the common data activity window held on the high speed memory device at block 1095. This time can be used as the end point for the window of time new occurrences of a given threat mode (represented by the first step of its definition) would be analyzed for occurrence. The process can then subtract the amount of time specified by the activation time threshold in the threat model definition's first step to determine the earliest point in time that data activity meeting criteria is analyzed for at block 1100. The start and end points determined are given to the calling process for use in criteria to create a window of time within the common data activity during which data is searched for items meeting other criteria.

Referring now to FIG. 25B, this figure is a logic flow diagram illustrating a process for determining the related time criteria for a given threat model step based on an existing state. This process can begin by identifying the Previous Time attribute value in the state's record as the beginning time in which common data activity meeting criteria is analyzed for at block 1105. This attribute can be updated by the analysis process each time criteria is met to simulate a moving window of time in data activity as it relates to this point in the provided threat model. The process can then determine whether or not the state is currently activated at block 1110, meaning it is in a state of having met its activation criteria. If the state requires activation criteria to be used, the activation time threshold criteria is identified and used as time threshold criteria at block 1115. If activation criteria is currently met by this point in the threat model, sustained (also referred to as continuance) time threshold criteria is identified for use in determining the appropriate time window for data activity time criteria at block 1120. After the appropriate criteria is determined, the amount of time represented by the appropriate time threshold criteria is added to the previous time value (representing the beginning window time of sought activity) resulting in the ending point in time for which criteria meeting data activity is to be analyzed at block 1125. The start and end points determined are given to the calling process for use in criteria to create a window of time within the common data activity in which data is searched for items meeting other criteria.

Referring now to FIG. 26, this figure is a logic flow diagram illustrating the sub process of analysis in which success actions are performed or updated in relationship to a threat model's success in meeting final step criteria. This process can begin by retrieving all success actions from persistent storage associated with the provided threat model and entity for this sub process at block 1130. The process can then loop on each identified success action for the given threat model and entity (the loop starting at block 1140). Per each action, the process can then determine whether or not an existing action is present on the high speed memory, utilizing the unique identifier for each action and the associated threat model occurrence group identifier at block 1145. If the success action already exists, an update can be made to the existing action, which can include information relevant to the current occurrence of the associated threat model at block 1160. If no associated success action exists for the given action, the success action can be performed as interpreted by the process and its definition in persistent storage at block 1150. One potential success action may be to alert a defined user via email or to create a corroboration job to be performed with an assigned strategy on the events identified by common data activity analysis. Upon performing any success action, the process can then add a unique identifier to the action, associated threat model, and associated threat model occurrence, in the high speed memory device, for later reference at block 1155. The process can then determine whether or not an addition success action exists, continuing to perform each defined success action associated with the given threat model, completing the loop on each success action so associated at block 1165. The process can then determine whether or not the provided threat model contains a single step or more in its definition to determine the path to take to return to its calling process at block 1170.

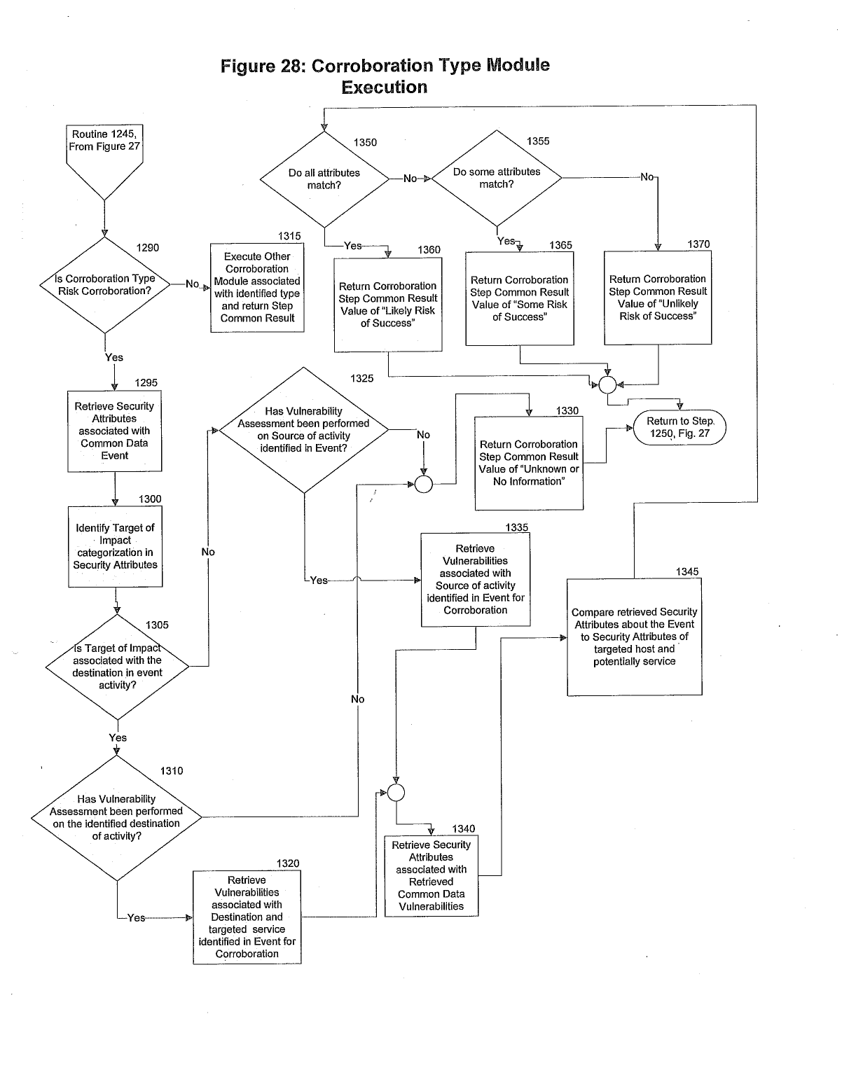

Referring now to FIG. 27, this figure is a logic flow diagram illustrating the process of performing corroboration jobs. Each corroboration job represents one to many identified events meeting a defined corroboration policy that require corroboration using the associated corroboration strategy with each policy. Common data events that meet each corroboration policy item can be identified utilizing the same process as threat model analysis, providing a single or multi-step threat model as associated criteria for identifying events needing corroboration using the chosen and assigned corroboration strategy with each policy item. However, one skilled in the art would be able to build other implementations of this process for identifying activity for corroboration. This process can begin by retrieving all defined corroboration strategies from persistent storage at block 1190. The process can then retrieve all entities scheduled for corroboration from persistent storage at block 1195. The process can then loop on each identified corroboration entity (the loop starting at block 1200). Per each entity, the process can then retrieve a list of all storage locations of common event data belonging to the current entity from persistent storage at block 1205. The process can then loop on each identified data store (the loop starting at block 1210). Per each data store belonging to the entity, the process can then connect to the current data store using the retrieved information at block 1215. The process can then retrieve all unperformed corroboration jobs for the provided entity and data store from the data store's persistent storage, at block 1220. The process can then loop on each unperformed corroboration job (the loop starting at block 1225). Per each corroboration job, the process can identify the associated corroboration strategy assigned to the corroboration policy that created the job at block 1230. The process can then loop on each step of the identified corroboration strategy (the loop starting at block 1235). Per each step of the associated corroboration strategy, the process can then identify the type of corroboration defined to be performed in the given corroboration strategy step at block 1240. The process can then perform the sub process of Corroboration Type Module Execution at block 1245, as illustrated in FIG. 28. Corroboration Type Modules can be any code implementation that performs a certain type of corroboration and returns a Corroboration Step common result, measuring the positive/negative result of its corroboration technique. The process can then take the corroboration step common result provided by the Corroboration Type Module executed and update the jobs corroboration result in high speed memory at block 1250. The process can then determine whether the common corroboration result for the given strategy step is more than the defined corroboration step termination minimum value, defined as part of each corroboration strategy step, at block 1255. If the corroboration result is determined to be equal or greater than the defined minimum, the process can then continue on to determine whether or not the corroboration result is less than or equal to the defined termination maximum value, also defined as part of each corroboration strategy step, at block 1260. Both the minimum and maximum termination values allow one skilled in the art to build a corroboration strategy that can begin with a step calling for the most “trusted” or “accurate” form of corroboration for the described data by its policy and then use termination criteria to allow or disallow following strategy steps to be performed, based on the results of each step. For example, if an “insufficient or no information” is determined to be the result of the first step, the following step may be executed, while in another example case, if the first step results in a “High Risk or Positive” result, the following step or steps of the associated corroboration strategy may be chosen not to be performed. If the result provided by the corroboration type module is discovered to be equal to or greater than the defined termination minimum value, at block 1255, and discovered to be equal to or lesser than the defined termination maximum value, at block 1260, the process can then continue on to determine whether or not another corroboration strategy step exists at block 1270. If another corroboration strategy step is determined to exist at block 1270, the process can continue on to perform the next step of the corroboration strategy at block 1235. If the result provided by the corroboration type module is discovered to be under the defined termination minimum value, at block 1255, or over the defined termination maximum value, at block 1260, or if another strategy step does not exist for the provided corroboration strategy, at block 1270, the process can then continue on to update the overall corroboration strategy result in high speed memory or persistent storage at block 1265. The process can then determine whether or not another unperformed corroboration job exists for processing at block 1275. If it is determined that another unperformed corroboration job exists for the current data store and entity, the process can continue on to perform the identified corroboration job at block 1225. If another unperformed corroboration job is not found to exist, the process can continue on to determine whether or not an additional data store for the current entity exists at block 1280. If another data store is determined to exist, the process can continue on to perform corroboration jobs on the next data store at block 1210. If no additional data store is found to exist for the current entity, the process can continue on to determine if another entity exists for corroboration at block 1285. If another entity exists for corroboration, the process may then continue on to perform corroboration for the given entity at block 1200. If no additional entity exists, the entire corroboration strategy processor may repeat at the Start block, continuing the described ongoing process.

Referring now to FIG. 28, this figure is a logic flow diagram illustrating the process of performing a provided corroboration strategy step's technique of corroboration, identified by its associated corroboration type in the strategy step's definition. This process can begin by determining the corroboration type and associated module to be executed for corroboration. More specifically, this process can first determine whether or not the corroboration type defined in the provided corroboration strategy step is Risk Corroboration at block 1290. If it is determined not to be Risk Corroboration, the process may continue on to execute the identified corroboration type module for the given strategy step and store the resulting corroboration common result in high speed memory for use by the strategy processor on return at block 1315. Many techniques are commonly used and can be automated as a corroboration type module used in the described invention. One example, other than Risk Corroboration that is enclosed as a uniquely automated technique, would be a module that determines whether or not the described activity in the provided event for corroboration did or did not pass through border infrastructure whose related data can be collected by this system. Another example would be a module that determines whether or not vulnerability exists on the target of impact of provided activity that specifically is associated with the identified attack in the common data activity event. Regardless of the corroboration type module developed, such a “pluggable” module can return a corroboration common result value, a list of resulting values representing the determined risk level to the target of impact resulting from the modules technique of corroboration, back after execution. If the defined corroboration type is determined to be Risk Corroboration, the process may continue on to retrieve all security attributes, stored in the present invention's knowledge base and/or persistent storage, that are associated with the provided event or events for corroboration at block 1295. As part of these retrieved knowledgebase attributes, the process may then continue on to determine whether or not the target of impact of the provided events is also the item described by the destination information in the provided common event data at block 1305. If the target of impact is determined to also be associated with the described destination in the common event data activity, the process can continue on to determine whether or not assessment has been performed for vulnerabilities existing in the described destination at block 1310. If it is determined that no assessment has been performed on the identified destination, the process can then continue on to store a common corroboration result value in high speed memory, representing “No information or indeterminable result” for use by the calling strategy processor at block 1330. If it is determined that assessment has been performed on the identified destination, the process can continue on to retrieve all vulnerability data information from persistent storage associated with the destination at block 1320. If it is determined that the target of impact is not associated with the destination described in the provided common data events, the process can continue on to determine whether or not vulnerability assessment has been performed on the source described in provided common data events at block 1325. If it is determined that no assessment has been performed on the identified source, the process can then continue on to store a common corroboration result value in high speed memory, representing “No information or indeterminable result” for use by the calling strategy processor at block 1330. If it is determined that assessment has been performed on the identified source, the process can continue on to retrieve all vulnerability data information from persistent storage associated with the source at block 1335. The process may then continue on to compare retrieved Security Attributes about the common data events provided for corroboration to security attributes associated with vulnerabilities retrieved for the target of impact at block 1345. The process can continue on to determine whether or not all associated attributes with the provided common data events match the attributes associated with the retrieved target of impacts vulnerabilities at block 1350. If all attributes are determined to match, the process may continue on to store a common corroboration result value, representing “Likely Risk of Success”, in high speed memory for use by the calling strategy processor at block 1360. If it is determined that not all attributes match, the process can continue on to determine whether some attributes match at block 1355. If it is determined that some attributes match, the process can continue on to store a common corroboration result value, representing “Some Risk of Success”, in high speed memory for use by the calling strategy processor at block 1365. If no attributes are found to match, the process can continue on to store a common corroboration result value, representing “Unlikely Risk of Success” in high speed memory for use by the calling strategy processor at block 1370. After each of these cases, the process can continue on to returning to the calling strategy processor, having stored the appropriate corroboration common result value to high speed memory for use.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

1. A system for analyzing security related network activity comprising:
a common data event database configured to store device event data in a common data event format; and
a threat model analysis engine configured to:
read common event data from the common data event database;
analyze the common event data by comparing the common event data to a threat model definition; and
generate a threat model instance corresponding to the threat model definition if a set of requirements of the definition is met by the common event data.

2. The system of claim 1, wherein the common data event format comprises a source Internet protocol address, a delimiter, and a source port.

3. The system of claim 1, wherein the common data event format comprises a destination Internet protocol address, a delimiter, and a destination port.

4. The system of claim 1 wherein the common data event format comprises a corroboration level field.

5. The system of claim 4 wherein the corroboration level field is initially set to zero for a common data event record stored in the common data event database.

6. The system of claim 1, wherein the common data event format comprises a timestamp.

7. The system of claim 6 wherein the threat model definition comprises a step definition.

8. The system of claim 7 wherein the step definition includes content criteria that identifies a common data type and an activity to be analyzed.

9. The system of claim 8 wherein the step definition comprises an active activity threshold which indicates a volume of activity required during a time period for a threat model step to be created and granted an initial status.

10. The system of claim 8 wherein the step definition comprises a sustained activity threshold which indicates a volume of activity required during a time period for the threat model step to be granted a sustained status.

11. The system of claim 8 wherein the step definition comprises a persistence type which identifies attributes required to be shared by threat model steps for the activity corresponding to those steps to be regarded as part of a common threat model instance.

12. The system of claim 6 wherein the threat model definition comprises a first step, a second step, and a relationship definition which identifies a relationship and inheritance properties between the first step and the second step.

13. The system of claim 6 wherein the threat model definition comprises a first step, a second step, and a relationship type which identifies data to be inherited from the first step by the second step.

14. The system of claim 13 wherein the threat model definition includes a source/destination switch indicator for switching destination information inherited from the first step by the second step to destination information.

15. The system of claim 1 wherein the common data event database includes at least one corroboration strategy.

16. The system of claim 1 further comprising:
an activity processor configured to:
receive device event data;
translate the data into a common data event format; and
store the translated data into the common data event database.

17. The system of claim 16 wherein the device event data is received from a first device and a second device, the data event data originating from an event log of the first device and an event log of the second device.

18. The system of claim 16 wherein the common data event format comprises a source Internet protocol address, a delimiter, and a source port

19. The system of claim 16 wherein the common data event format comprises a destination Internet protocol address, a delimiter, and a destination port

20. The system of claim 16 wherein the common data event format comprises a corroboration level field.

21. The system of claim 20 wherein the corroboration level field is initially set to zero for a common data event record stored in the common data event database.

22. The system of claim 17 wherein the event log of the first device has a first format and the event log of the second device has a second format, the activity processor being configured to read device event data in the first format and convert the data into a common data event format and mad device event data in the second format and convert the data into the common data event format.

23. The system of claim 26 wherein the activity processor comprises:
an activity collector module for collecting the device event data from one or more sources;
a common data dictionary which comprises mapping rules for converting fields of device event logs to a common data format; and
a common data translator module for translating the collected device data into the common data format based on the mapping rules of the common data dictionary.

24. The system of claim 1 wherein the threat model analysis engine generates the threat model instance corresponding to the threat model definition if a requisite volume of an activity defined in the threat model definition is met.

25. The system of claim 24 wherein the threat model analysis engine creates a first state of the threat model instance upon generation of the threat model instance.

26. The system of claim 25 wherein the threat model analysis engine creates a second state of the threat model instance for a target identified in the activity corresponding to the first state.

27. The system of claim 26 wherein the threat model analysis engine creates a state representing a second step in threat progression for a first and a second target identified in the activity corresponding to the first state.

28. The system of claim 27 wherein the threat model analysis engine monitors the common event data for additional threat model instance related activity corresponding to the first target and the second target.

29. The system of claim 25 wherein the threat model analysis engine monitors the activity volume of activity corresponding to the first step, compares the activity volume to a sustained activity threshold of the threat model definition, and determines that the first step is still active if the activity volume is meets the sustained activity threshold.

30. The system of claim 25 wherein the threat model instance includes a threat model instance identifier.

31. The system of claim 26 wherein the second state includes an indication of whether or not the activity corresponding to the state as defined in the threat model definition has occurred.

32. The system of claim 26 wherein the second state includes a list of the common data event records associated with the second state having met criteria defined in the threat model definition.

33. The system of claim 26 wherein the second state includes a list of values inherited from the first step.

34. The system of claim 26 wherein the second state Includes an indication of whether the state has been promoted, being promoted indicating that the state will continue to be monitored based on the status of the first state.

35. The system of claim 1 further comprising an interface console, the interface console being configured to accept threat model definition criteria from a user for creation of a threat model definition.

36. The system of claim 1 further comprising an interface console, the interface console being configured to demonstrate a threat model instance on a display of the console.

37. The system of claim 1 further comprising:
a corroboration job processor, the corroboration job processor being configured to:
retrieve a set of corroboration strategies;
retrieve security attributes associated with a common data event;
retrieve security attributes associated with a targeted service; and
return a risk assessment based on a comparison of the common data event security attributes and the targeted service security attributes.

38. A system for creating a threat model definition comprising:
a processor;
a computer readable memory;
an interface console; and
instructions for making the processor operable to:
prompt a user for threat model definition parameters;
receive threat model definition parameters from the user;
generate a threat model definition based on the threat model definition parameters received from the user.

39. The system of claim 38 wherein the user prompting includes a prompt for a name of the threat model definition being created.

40. The system of claim 38 wherein the user prompting includes a prompt for step definition parameters, the step definition parameters including a common data type and at least one parameter identifying an activity to be analyzed in the step.

41. The system of claim 40 wherein the step definition parameters further include an active activity threshold representing a volume of activity required during a period of time for a threat to be granted initial status.

42. The system of claim 40 wherein the step definition parameters further include a sustained activity threshold representing a volume of activity required during a period of time for a threat to be granted a sustained status.

43. The system of claim 40 wherein the step definition parameters further include a persistence type identifying one or more attributes required to be shared among activity meeting the step criteria.

44. The system of claim 40 wherein the step definition parameters further include a relationship definition identifying the relationship between two steps of the threat model definition.

45. The system of claim 40 wherein the step definition parameters further include a relationship type identifying fields of data to be inherited by one step of the threat model definition from another.

46. The system of claim 40 wherein the step definition parameters further include a source/destination switch indicator which indicates whether the destination: information from one step of the threat model definition is to be used as source information for another.
